(19) United States
(12) Patent Application Publication
(10) Pub. No.: US 2026/0152991 A1
(43) Pub. Date: Jun. 4, 2026

(54) Entry Device

(71) Applicant: Ameristar Perimeter Security USA Inc., Tulsa, OK (US)

(72) Inventor: Nathan T. Haney, Owasso, OK (US)

(21) Appl. No.: 18/967,843

(22) Filed: Dec. 4, 2024

(51) Int. Cl. E06B 3/70; E06B 1/52

(52) U.S. Cl. CPC E06B 3/7009; E06B 1/52

(57) ABSTRACT

An entry device is formed from upper and lower entry components. Each entry component is formed from a jamb having pair of parallel standing sections. A swinging door is attached to one of the standing sections of each jamb. A standing section of a jamb of the upper entry component can be joined to an aligned standing section of a jamb of the lower entry component. Opposite ends of a tubular splicing element are concurrently received within the hollow ends of the aligned standing sections. Fasteners that pass through aligned openings in the splicing element and a standing section effect the connection. The entry components can be disassembled for storage and transport, and reassembled where the entry device is to be installed. An L-shaped door connection bracket can join the doors of the assembled entry device, so that the doors open and close as a unit.

### SUMMARY OF THE INVENTION

A kit is formed from an upper entry component and a lower entry component.

The upper entry component includes an upper jamb and a swinging upper door. The upper jamb is formed from three sections that cooperate to define boundaries of an upper entryway. The three sections are a first standing section, a second standing section, and a header section.

The upper door is pivotally attached to the first standing section and positionable within the upper entryway. The second standing section extends parallel to the first standing section. The header section permanently interconnects the first and second standing sections.

The lower entry component is assemblable with, but disassembled from, the upper entry component. It includes a lower jamb and a swinging lower door. The lower jamb is formed from two sections that cooperate to define boundaries of a lower entryway. The two sections are a first standing section and a second standing section.

The lower door is pivotally attached to the first standing section and positionable within the lower entryway. The second standing section extends parallel to the first standing section.

An entry device is formed from an upper entry component, a lower entry component and two splicing elements.

The upper entry component includes an upper jamb and a swinging upper door. The upper jamb is formed from three sections that cooperate to define boundaries of an upper entryway. The three sections are a first standing section, a second standing section, and a header section.

The upper door is pivotally attached to the first standing section and positionable within the upper entryway. The second standing section extends parallel to the first standing section. The header section permanently interconnects the first and second standing sections.

The lower entry component is formed separately from the upper entry component. It includes a lower jamb and a swinging lower door. The lower jamb is formed from two sections that cooperate to define boundaries of a lower entryway. The two sections are a first standing section and a second standing section.

The lower door is pivotally attached to the first standing section and positionable within the lower entryway. The second standing section extends parallel to the first standing section.

A first splicing element joins the first standing sections of the upper and lower jambs, while a second splicing element joins the second standing sections of the these jambs.

### BRIEF DESCRIPTION OF THE DRAWINGS

FIG. 1 is a front elevation view of an entry device.

FIG. 2 is a rear elevation view of the entry device shown in FIG. 1.

FIG. 3 is a right side view of the entry device shown in FIG. 1, taken from plane 3-3.

FIG. 4 is a front elevation view of the upper jamb of the entry device shown in FIG. 1.

FIG. 5 is a rear elevation view of the upper jamb shown in FIG. 4.

FIG. 6 is a cross-sectional view of the first standing section of the upper jamb shown in FIG. 4, taken from plane 6-6.

FIG. 7 is a side cross-sectional view of the upper jamb shown in FIG. 4, taken from plane 7-7.

FIG. 8 is a front elevation view of the upper door of the entry device shown in FIG. 1.

FIG. 9 is a rear elevation view of the upper door shown in FIG. 8.

FIG. 10 is a top plan view of the upper door shown in FIG. 8, taken from plane 10-10.

FIG. 11 is a left side view of the upper door shown in FIG. 8, taken from plane 11-11.

FIG. 12 is a right side view of the upper door shown in FIG. 8, taken from plane 12-12.

FIG. 13 is a perspective view of the first standing section of the lower jamb of the entry device shown in FIG. 1.

FIG. 14 is a front elevation view of the first standing section shown in FIG. 13.

FIG. 15 is a cross-sectional view of the first standing section shown in FIG. 14, taken from plane 15-15.

FIG. 16 is a right side view of the first standing section shown in FIG. 14, taken from plane 16-16.

FIG. 17 is a perspective view of the second standing section of the lower jamb of the entry device shown in FIG. 1.

FIG. 18 is a front elevation view of the second standing section shown in FIG. 17.

FIG. 19 is a cross-sectional view of the second standing section shown in FIG. 18, taken from plane 19-19.

FIG. 20 is a left side view of the second standing section shown in FIG. 18, taken from plane 20-20.

FIG. 21 is a front elevation view of the lower door of the entry device shown in FIG. 1.

FIG. 22 is a rear elevation view of the lower door shown in FIG. 21.

FIG. 23 is a top plan view of the lower door shown in FIG. 21, taken from plane 23-23.

FIG. 24 is a right side view of the lower door shown in FIG. 21, taken from plane 24-24.

FIG. 25 is a left side view of the lower door shown in FIG. 21, taken from plane 25-25.

FIG. 26 is a perspective view of a door positioning piece for the entry device shown in FIG. 1.

FIG. 27 is a front elevation view of the door positioning piece shown in FIG. 26.

FIG. 28 is a top plan view of the door positioning piece shown in FIG. 27, taken from plane 28-28.

FIG. 29 is a right side view of the door positioning piece shown in FIG. 27, taken from plane 29-29.

FIG. 30 is a perspective view of an upper entry component formed from the assembled upper jamb shown in FIG. 4 and the upper door shown in FIG. 8. The door positioning piece shown in FIG. 26 holds the upper door within the upper jamb.

FIG. 31 is a front elevation view of the upper entry component shown in FIG. 30.

FIG. 32 is a top plan view of the upper entry component shown in FIG. 31, taken from plane 32-32.

FIG. 33 is a right side view of the upper entry component shown in FIG. 31, taken from plane 33-33.

FIG. 34 is a perspective view of a lower entry component formed from the assembled left and right upright sections of the lower jamb, shown in FIGS. 13 and 17, and the lower door shown in FIG. 21. Two of the door positioning pieces shown in FIG. 26 hold the lower door within the lower jamb.

FIG. 35 is a front elevation view of the lower entry component shown in FIG. 34.

FIG. 36 is a top plan view of the lower entry component shown in FIG. 35, taken from plane 36-36.

FIG. 37 is a right side view of the lower entry component shown in FIG. 35, taken from plane 37-37.

FIG. 38 is an upper perspective view of a footing.

FIG. 39 is a lower perspective view of the footing shown in FIG. 38.

FIG. 40 is a front elevation view of the footing shown in FIG. 38.

FIG. 41 is a top plan view of the footing shown in FIG. 40, taken from plane 41-41.

FIG. 42 is a right side view of the footing shown in FIG. 40, taken from plane 42-42.

FIG. 43 is a perspective view of another footing.

FIG. 44 is a perspective, partially exploded view of an initial stage of the assembly of the lower entry component shown in FIG. 34 with two of the footings shown in FIG. 38. The window panel is omitted.

FIG. 45 is a perspective view showing the finished assembly begun in FIG. 44.

FIG. 46 is a perspective view of a splicing element.

FIG. 47 is a front elevation view of the splicing element shown in FIG. 46.

FIG. 48 is a top plan view of the splicing element shown in FIG. 47, taken from plane 48-48.

FIG. 49 is a right side view of the splicing element shown in FIG. 47, taken from plane 49-49.

FIG. 50 is a perspective, partially exploded view of an initial stage of the assembly of the upper entry component shown in FIG. 30 with two of the splicing elements shown in FIG. 46. The window panel is omitted.

FIG. 51 is a perspective view showing the finished assembly begun in FIG. 50.

FIG. 52 is a perspective, partially exploded view of an initial stage of the assembly of the connector-bearing upper entry component shown in FIG. 51 with the foot-bearing lower entry component shown in FIG. 45. Window panels are omitted.

FIG. 53 is a perspective, partially exploded view showing a later stage of the assembly begun in FIG. 52.

FIG. 54 is a front elevation view of a door connection bracket for the entry device shown in FIG. 1.

FIG. 55 is a top plan view of the door connection bracket shown in FIG. 54, taken from plane 55-55.

FIG. 56 is a right side view of the door connection bracket shown in FIG. 54, taken from plane 56-56.

FIG. 57 is a front perspective, partially exploded view of the lower part of the assembly shown in FIG. 53, in preparation for assembly with the door connection bracket shown in FIG. 54. The window panel is omitted.

FIG. 58 is a rear perspective view of the assembly shown in FIG. 57, after assembly with the door connection bracket is complete.

### DETAILED DESCRIPTION

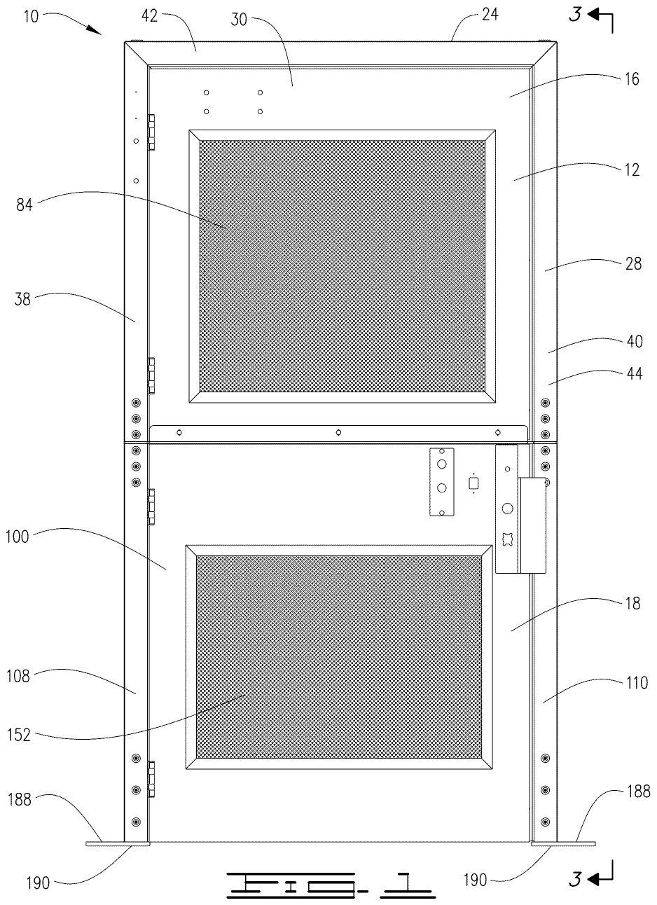

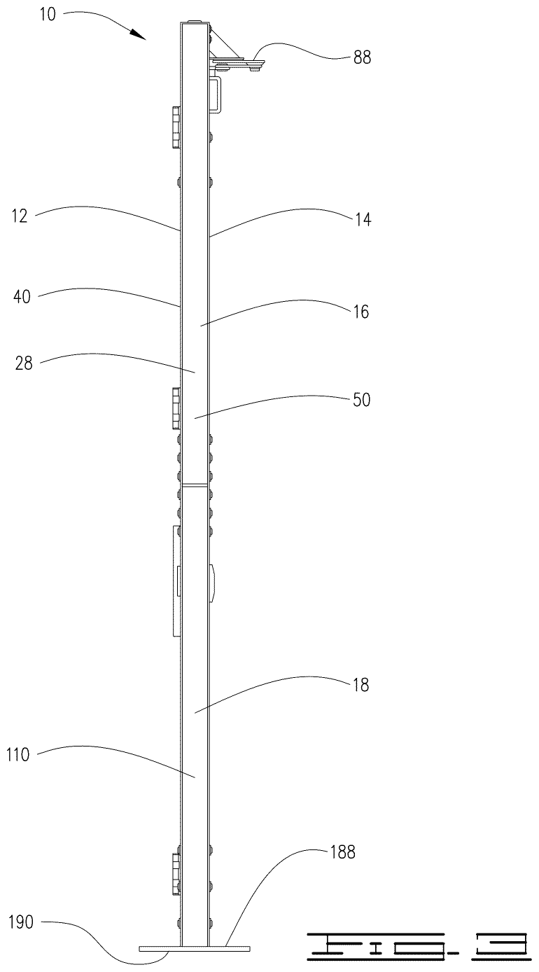

An entry device 10, shown in FIGS. 1-3, may comprise a door or gate that is formed or installed within a barrier or enclosure. The entry device 10 has a front side 12 and a parallel and opposed rear side 14.

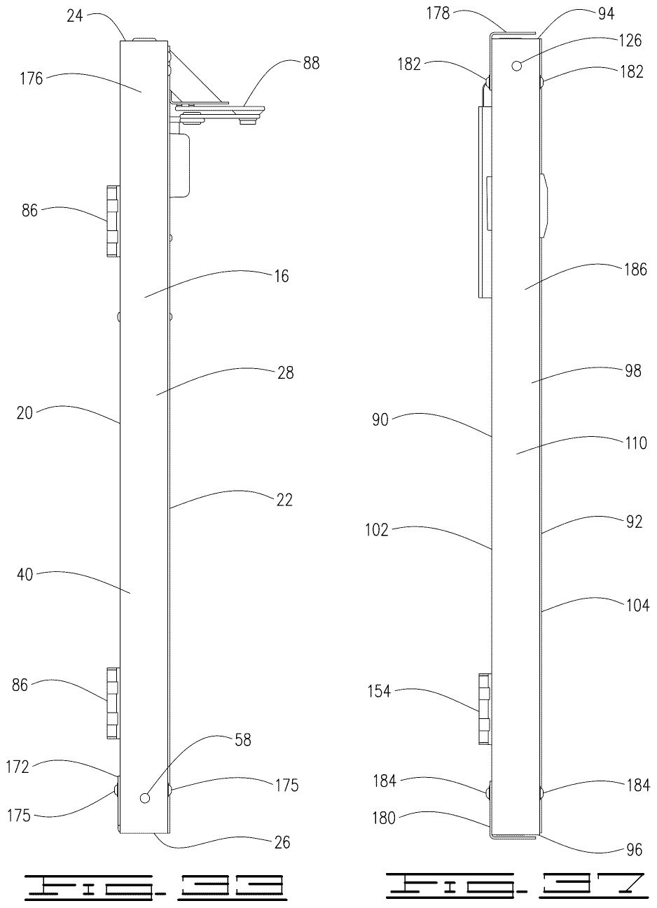

The entry device 10 is formed from an upper entry component 16 and a lower entry component 18. The upper entry component 16, shown in FIGS. 1-3 and 30-33, is bounded by a front side 20, a parallel and opposed rear side 22, an upper side 24 and a parallel and opposed lower side 26. The sides 24 and 26 join the sides 20 and 22, and extend in orthogonal relationship thereto.

The upper entry component 16 is formed from an upper jamb 28 and a swinging upper door 30. As shown in FIGS. 4-7, the upper jamb 28 is a C-shaped structure having a front side 32 and a parallel and opposed rear side 34. It is formed from three and only three sections that cooperate to define boundaries of an upper entryway 36. The three sections are a first standing section 38, a second standing section 40 and a header section 42.

The standing sections 38 and 40 extend in spaced, parallel and side-by side relationship, and are preferably of identical size, shape and construction. Each of the standing sections 38 and 40 is an elongate and rectilinear tubular member of preferably rectangular, and more preferably square, cross-sectional shape.

Each standing section is bounded by a flat front side 44, a parallel, opposed and flat rear side 46, a flat inner side 48 and a parallel, opposed and flat outer side 50. The sides 44 and 46 respectively coincide with the front and rear sides 32 and 34 of the upper entry component 16, as well as with the front and rear sides 12 and 14 of the entry device 10. The sides 48 and 50 join the sides 44 and 46, and extend in orthogonal relationship thereto. The inner side 48 adjoins and faces the upper entryway 36, while the outer side 50 does not adjoin, and faces away from, that entryway.

Each of the standing sections 38 and 40 has an upper end 52 and an opposed lower end 54, and preferably is hollow adjacent each of these ends. More preferably, each standing section 38 and 40 is hollow from end to end. Adjacent its lower end 54, each standing section 38 and 40 is provided with a longitudinally-spaced series of fastener openings 56 in each of the front and rear sides 32 and 34. The fastener openings 56 in each side are preferably collinear, and aligned with the fastener openings 56 formed in the opposite side.

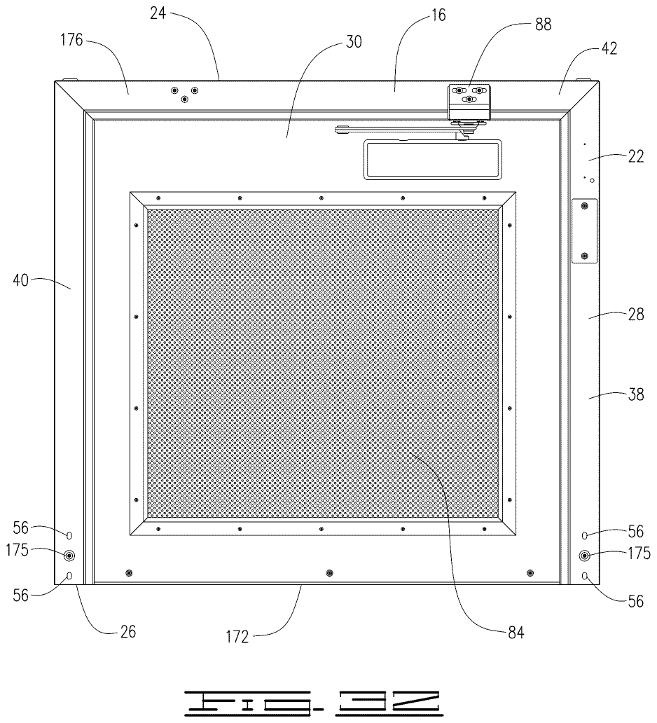

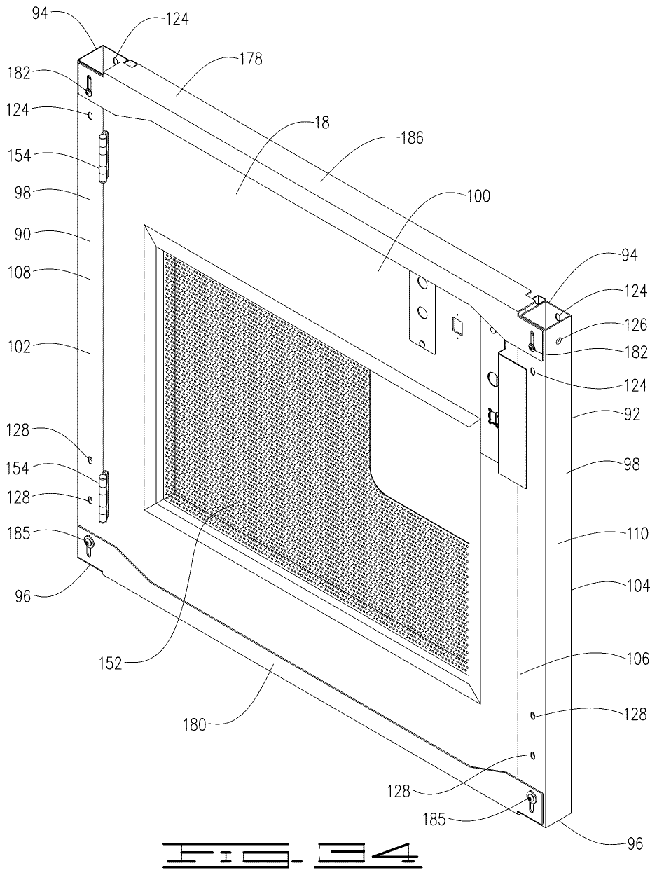

Also adjacent its lower end 54, each standing section 38 and 40 is provided with at least one, and preferably only one fastener opening 58 (shown in FIGS. 30 and 33) formed in the outer side 50.

The header section 42 is another elongate and rectilinear tubular member. It permanently interconnects the standing sections 38 and 40, and extends orthogonally to them. The header section 42 preferably has the same cross-sectional size and shape as the standing sections 38 and 40.

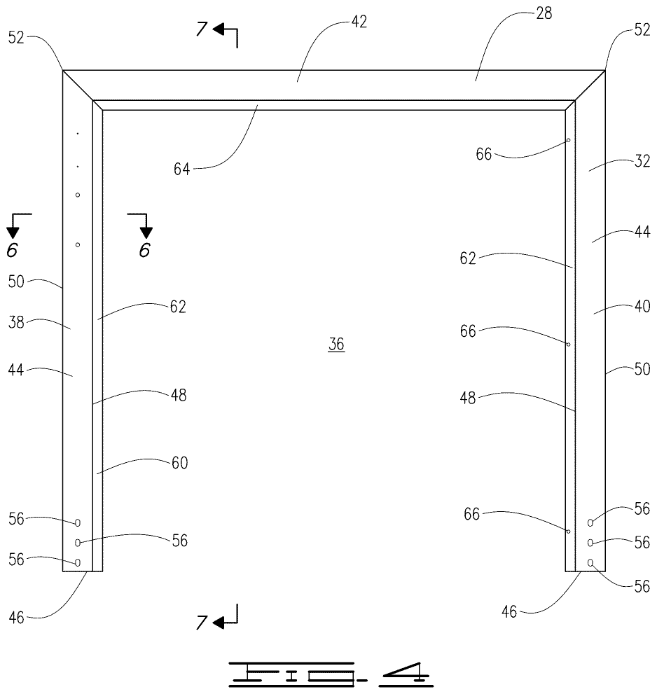

Adjoining sections of the upper jamb 28 are connected, preferably permanently, by welding or fasteners. As shown in FIGS. 4 and 5, mitered joints are preferably formed at connections between the sections.

The sections of the upper jamb 28 should be formed from a strong and durable material, such as steel or aluminum. Suitable steels include pre-galvanized steel and stainless steel. In one embodiment, each of the sections 38, 40 and 42 is square tubing having a 3-inch side, and is formed from 12-gauge galvanized steel. The standing sections 38 and 40 each have an inside length of 47.25 inches and an outside length of 50.15 inches. The header section 42 has an inside length of 48.38 inches and an outside length of 54.17 inches.

The upper jamb 28 preferably further comprises a stop 60 that prevents the upper door 30 from overswinging as it reaches its closed position. Instead, upon closing, the upper door 30 seats against the stop 60. The stop 60 is formed from a pair of parallel and upright side sections 62 of identical shape and size. The side sections 62 are joined at their upper ends by an orthogonal upper section 64, preferably having the same cross-sectional size and shape as the side sections 62. Preferably each of the sections is tubular along its entire length.

The sections 62 and 64 form a flat and C-shaped structure that fits within the upper entryway 36. Each section 62 and 64 is permanently joined to the section of the upper jamb 28 that underlies it, preferably by welding or fasteners. Adjacent sections of the stop 60 are likewise permanently joined to one another, again preferably by welding or fasteners. As shown in FIGS. 4 and 5, mitered joints are preferably formed at the connections between the sections.

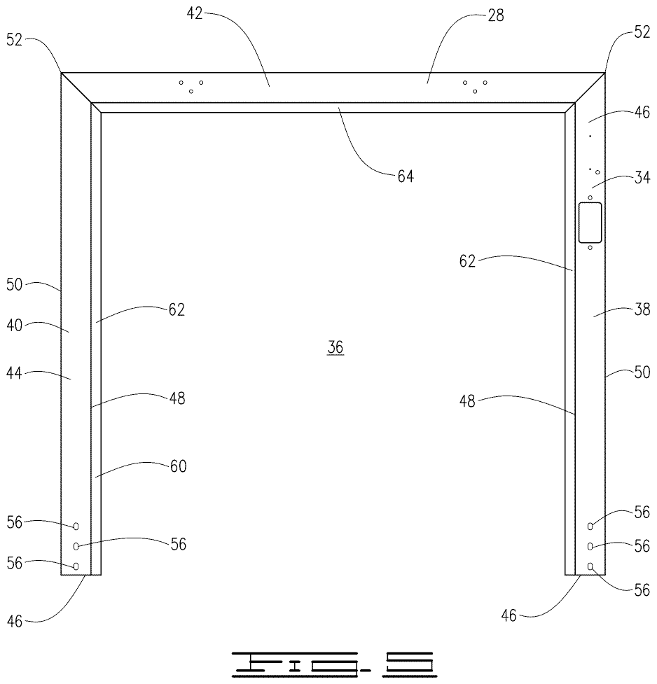

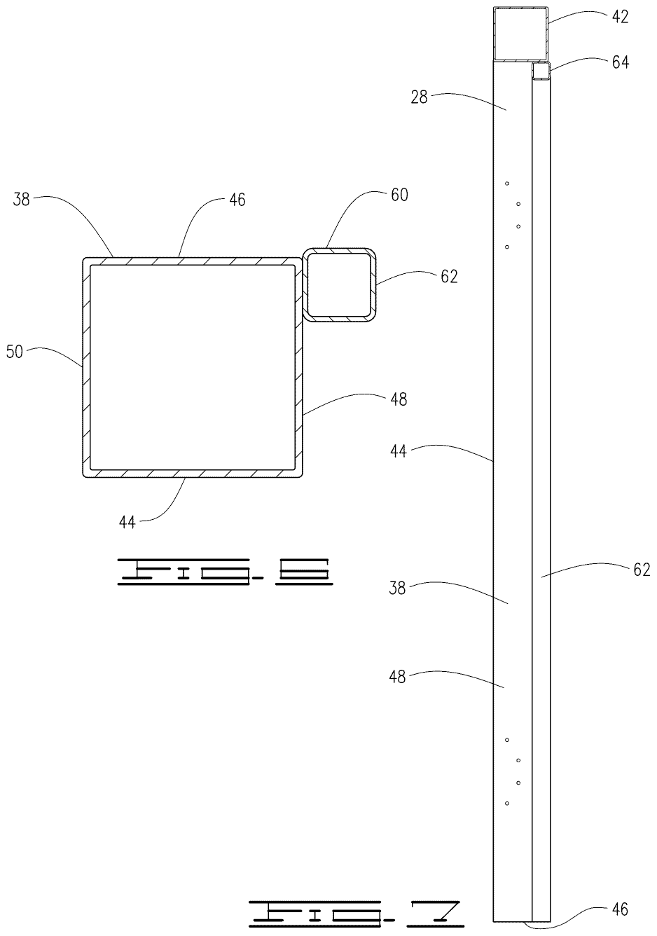

As best shown in FIGS. 6 and 7, each section 62 and 64 is situated nearest the rear side 34 of the upper jamb 28, and projects slightly outside its footprint. Optionally, a plurality of vertically-spaced fastener openings 66 may be formed in the side section 62 that engages the upper door 30, as shown in FIG. 4. Silencer pads (not shown) may be attached to the stop 60 at the fastener openings 66, in order to cushion the upper door 30 and reduce noise at closure. Three such fastener openings 66 are provided in the embodiment shown in the Figures.

The sections 62 and 64 should be formed from a strong and durable material, such as steel or aluminum. Suitable steels include pre-galvanized steel and stainless steel. In one embodiment, each of the sections 62 and 64 is square tubing having a 1-inch side, and is formed from 14-gauge sheet steel. Each section projects 0.125 inches outside the footprint of the upper jamb 28. The sections 62 each have an inside length of 46 inches and an outside length of 47 inches. The upper section 64 has an inside length of 46.38 inches and an outside length of 48.38 inches.

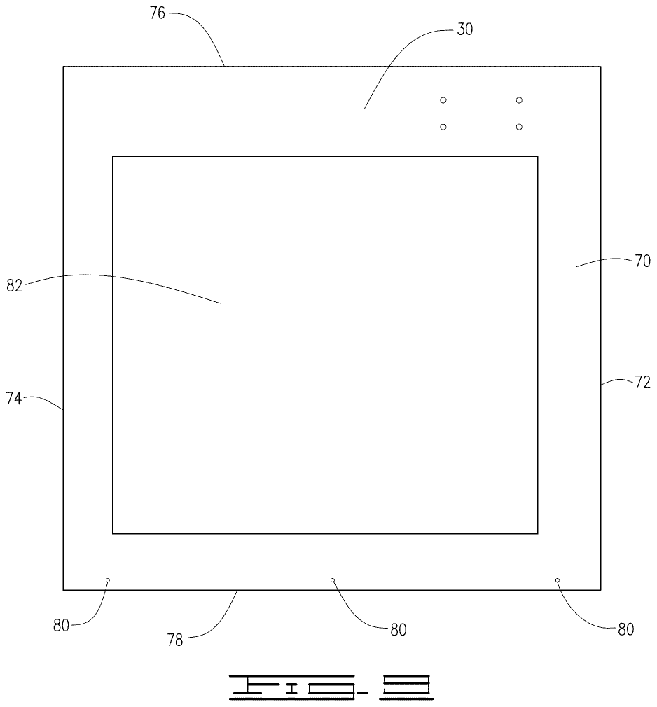

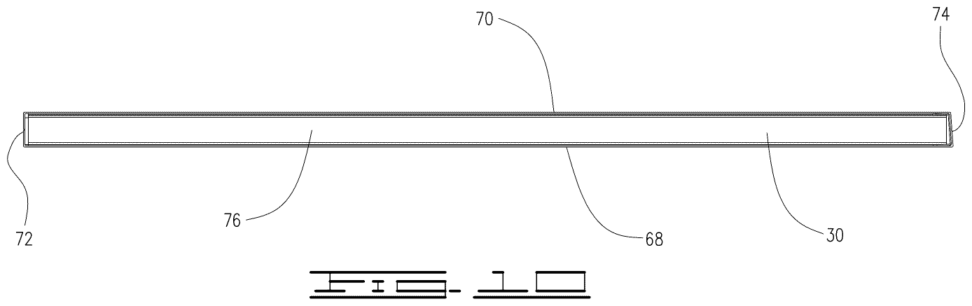

The upper door 30, shown in FIGS. 8-12, is a rectangularly-shaped structure sized to be closely but clearingly received within the upper entryway 36. It has a front side 68, a parallel and opposed rear side 70, an upright hinge side 72, a parallel and opposed latch side 74, an upper side 76 and a parallel and opposed lower side 78. As shown in the Figures, the sides 72 and 74 join the sides 68 and 70, while the sides 68, 70, 72 and 74 join the sides 76 and 78.

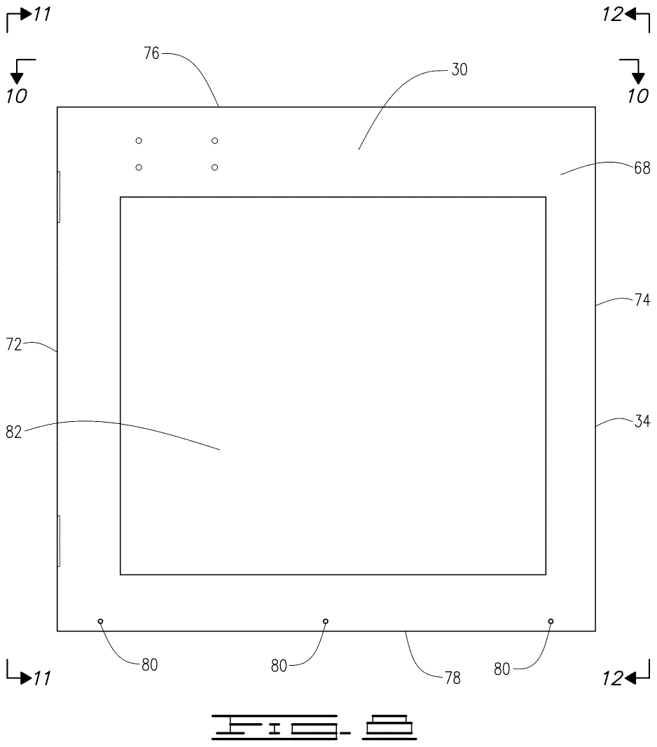

As shown in FIGS. 8 and 9, a plurality of fastener openings 80 are formed in the upper door 30 adjacent its lower side 78. The fastener openings 80 extend between the sides 68 and 70, and are preferably collinear. In addition, at least one, and preferably only one window opening 82 is formed in the upper door 30, extending between the sides 68 and 70. A modular and removable window panel 84 is preferably installed in each such window opening 82, as shown in FIGS. 1, 2 and 30-32. The window panel 84 is preferably fitted with a barrier-type infill material.

The upper door 30 should be formed from a strong and durable material, such as steel or aluminum. Suitable steels include pre-galvanized steel and stainless steel. In one embodiment, the upper door 30 is formed from 14-gauge galvanized steel and has a width of 54.375 inches, a height of 50.125 inches, and a thickness of 1.79 inches. The single window opening 82 has a width of 37.81 inches and a height of 33.56 inches. The fastener openings 80 are three in number, with a separation distance of 20 inches between adjacent openings.

The upper door 30 is positioned within the upper entryway 36 such that the hinge side 72 faces the inner side 48 of the first standing section 38, and such that the latch side 74 faces the inner side 48 of the second standing section 40. Adjacent the hinge side 72, a plurality of hinges 86, shown in FIGS. 30 and 31, effect pivotal attachment of the upper door 30 to the first standing section 38. The hinges 86 are interposed between the upper door 30 and the first standing section 38 and partially project from the front side 12 of the entry device 10. In the embodiment shown in the Figures, two such hinges 86 are provided.

The hinges 86 permit the upper door 30 to swing between a closed position, shown in FIG. 30, and an open position (not shown). In its closed position, the upper door 30 is fully situated within the upper entryway 36. In its open position, much or all of the upper door 30 is positioned outside the upper entryway 36, so that individuals and other traffic may traverse the barrier within which the entry device 10 is installed.

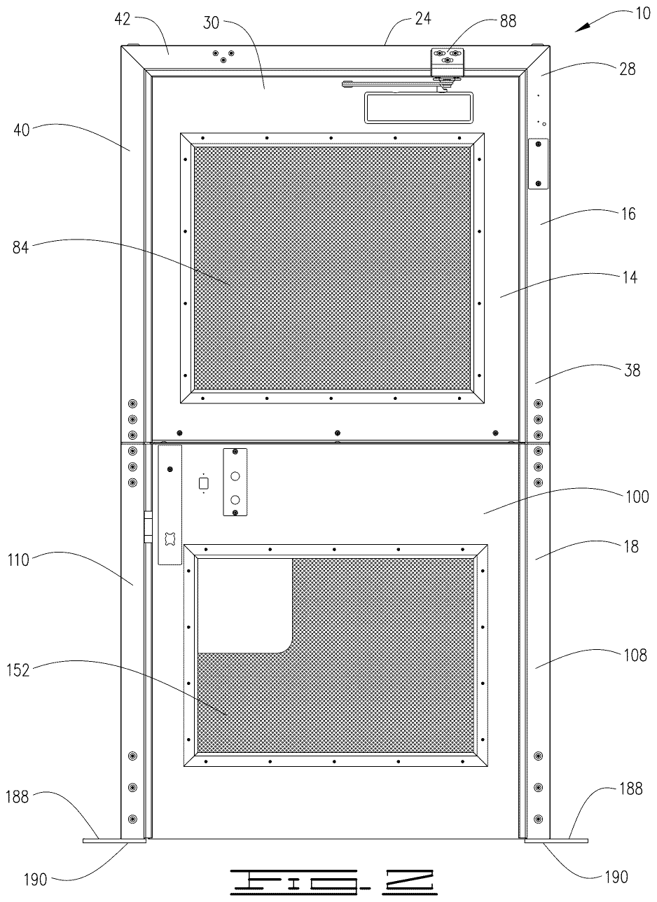

On its rear side 70, the upper door 30 is optionally provided with a closer mechanism 88, shown in FIGS. 2, 3, 32 and 33. The closer mechanism 88 is connected to the rear side 34 of the upper jamb 28, biases the upper door 30 toward its closed position and prevents slamming.

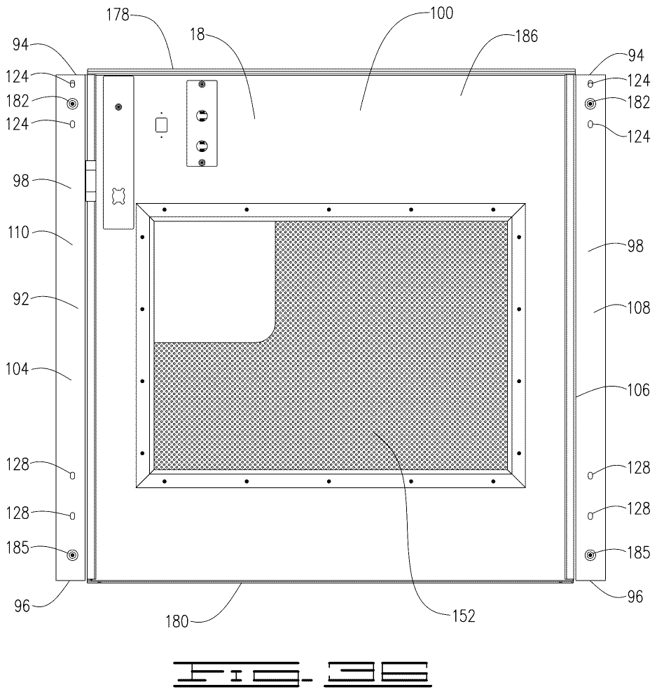

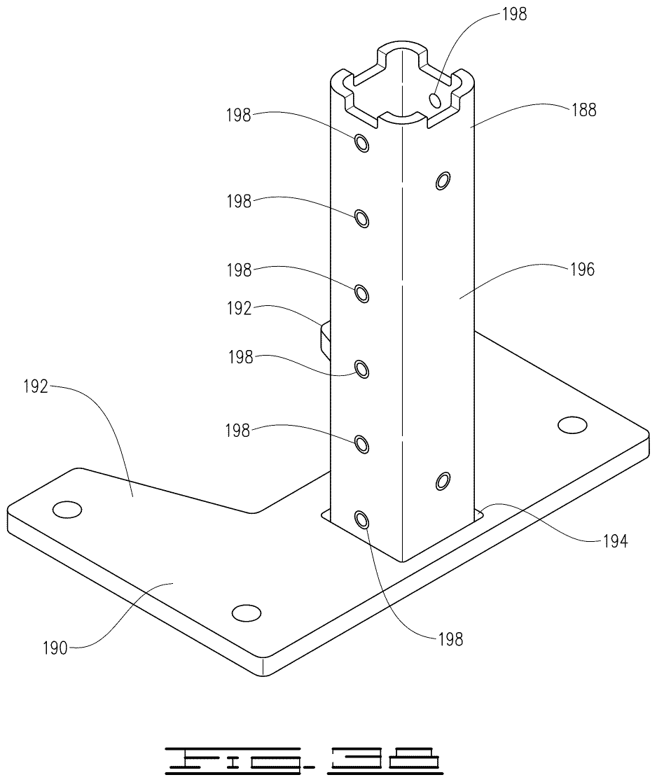

The lower entry component 18, shown in FIGS. 1-3 and 34-37, is bounded by a front side 90, a parallel and opposed rear side 92, an upper side 94 and a parallel and opposed lower side 96. The sides 94 and 96 join the sides 90 and 92, and extend in orthogonal relationship thereto.

The lower entry component 18 is formed from a lower jamb 98 and a swinging lower door 100.

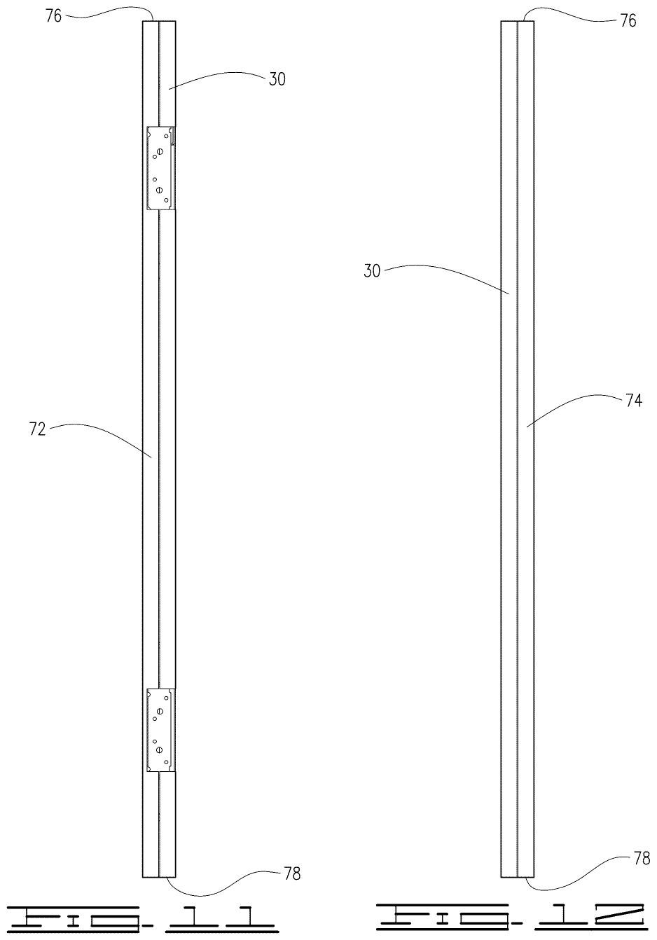

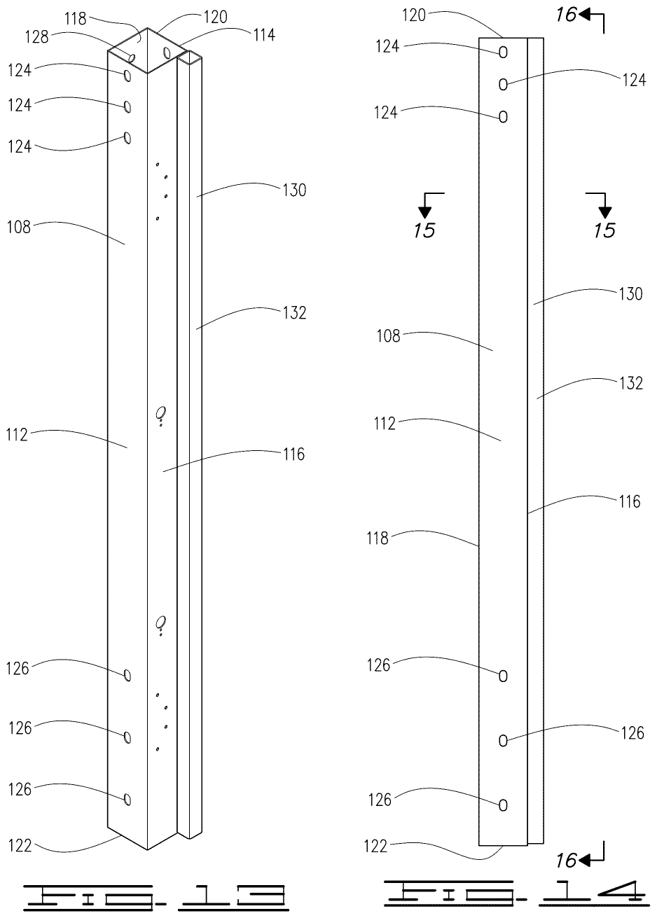

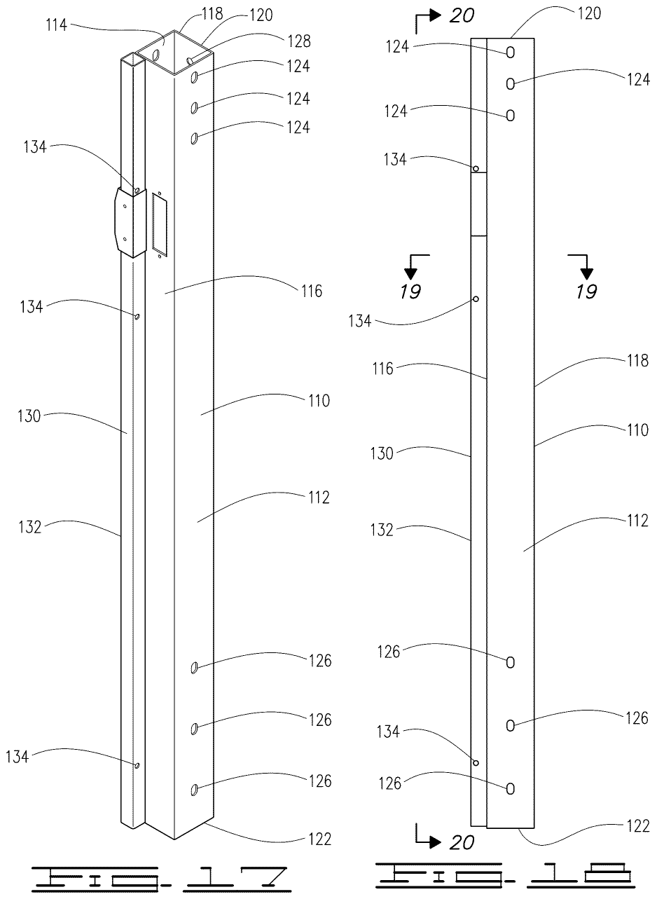

The lower jamb 98 has a front side 102 and a parallel and opposed rear side 104, and is formed from two sections that cooperate to define boundaries of a lower entryway 106. The two sections are a first standing section 108, shown in FIGS. 13-16, and a second standing section 110, shown in FIGS. 17-20.

The standing sections 108 and 110 extend in spaced, parallel and side-by side relationship, and are preferably of identical size, shape and construction. Each of the standing sections 108 and 110 is an elongate and rectilinear tubular member of preferably rectangular, and more preferably square, cross-sectional shape.

Each standing section is bounded by a flat front side 112, a parallel, opposed and flat rear side 114, a flat inner side 116 and a parallel, opposed and flat outer side 118. The sides 112 and 114 respectively coincide with the front and rear sides 90 and 92 of the lower entry component 18, as well as with the front and rear sides 12 and 14 of the entry device 10. The sides 116 and 118 join the sides 112 and 114, and extend in orthogonal relationship thereto. The inner side 116 adjoins and faces the lower entryway 106, while the outer side 118 does not adjoin, and faces away from, that entryway.

Each of the standing sections 108 and 110 has an upper end 120 and an opposed lower end 122, and preferably is hollow adjacent each of these ends. More preferably, each standing section 108 and 110 is hollow from end to end.

Adjacent its upper end 120, each standing section 108 and 110 is provided with a longitudinally-spaced series of fastener openings 124 in each of the front and rear sides 112 and 114. The fastener openings 124 in each side are preferably collinear, and aligned with the fastener openings 124 formed in the opposite side. Also adjacent its upper end 120, each standing section 108 and 110 is provided with at least one, and preferably only one fastener opening 126 formed in the outer side 118.

Adjacent its lower end 122, each standing section 108 and 110 is provided with a longitudinally-spaced series of fastener openings 128 in each of the front and rear sides 114 and 116. The fastener openings 128 in each side are preferably collinear, and aligned with the fastener openings 128 formed in the opposite side. The fastener openings 128 in each side are likewise collinear with the fastener openings 124 formed in that side.

The standing sections 108 and 110 should be formed from a strong and durable material, such as steel or aluminum. Suitable steels include pre-galvanized steel and stainless steel. In one embodiment, each of the standing sections 108 and 110 is square tubing having a 3-inch side, and is formed from 12-gauge galvanized steel. Each of the standing sections 108 and 110 has a length of 50 inches.

Unlike the upper jamb 28, which includes the header section 42, the lower jamb 98 has no counterpart rectilinear structure that permanently joins the first and second standing sections 108 and 110. Instead, at least while the entry components 16 and 18 are disassembled, the standing sections 108 and 110 are temporarily joined by at least one elongate, rigid and removable door positioning piece, to be described hereafter.

The lower jamb 98 preferably further comprises a stop 130 that prevents the lower door 100 from overswinging as it reaches its closed position. Instead, upon closing, the lower door 100 seats against the stop 130. The stop 130 is formed from a pair of parallel and upright side sections 132 of identical shape and size. Preferably each of the sections is tubular along its entire length.

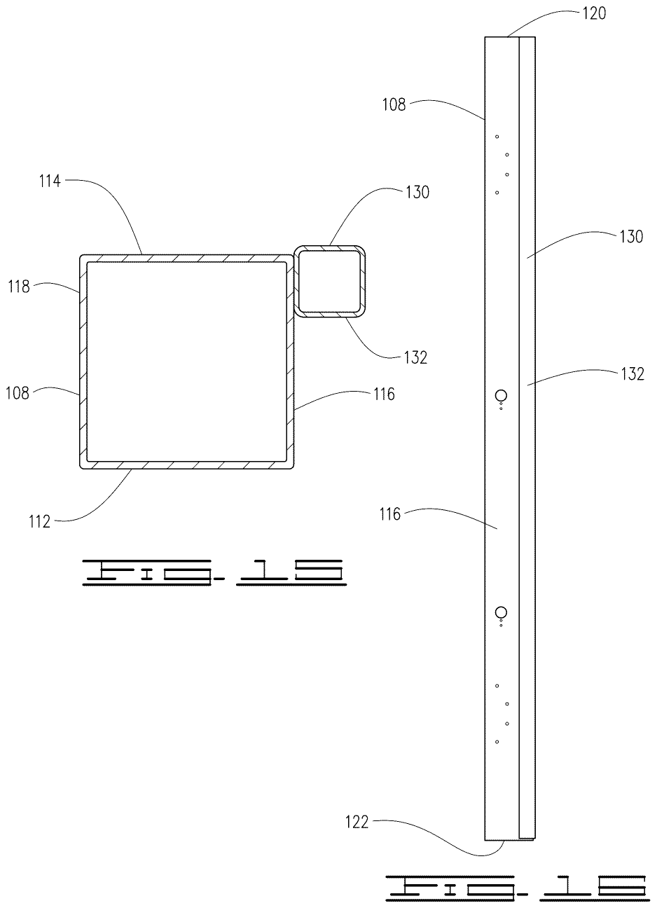

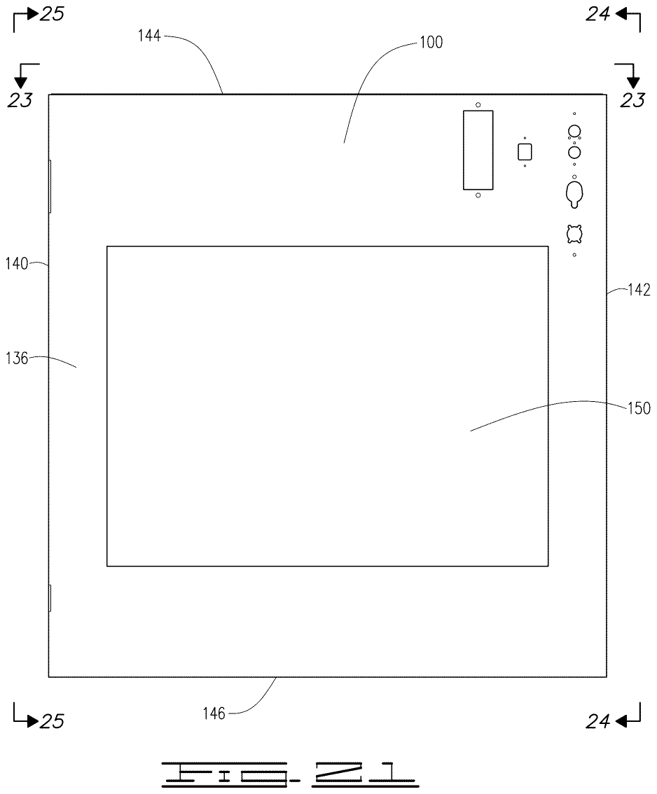

Each section 132 is permanently joined to the section of the lower jamb 98 that underlies it, preferably by welding or fasteners. As best shown in FIGS. 15 and 19, each section 132 is situated nearest the rear side 34 of the lower jamb 98, and projects slightly outside its footprint.

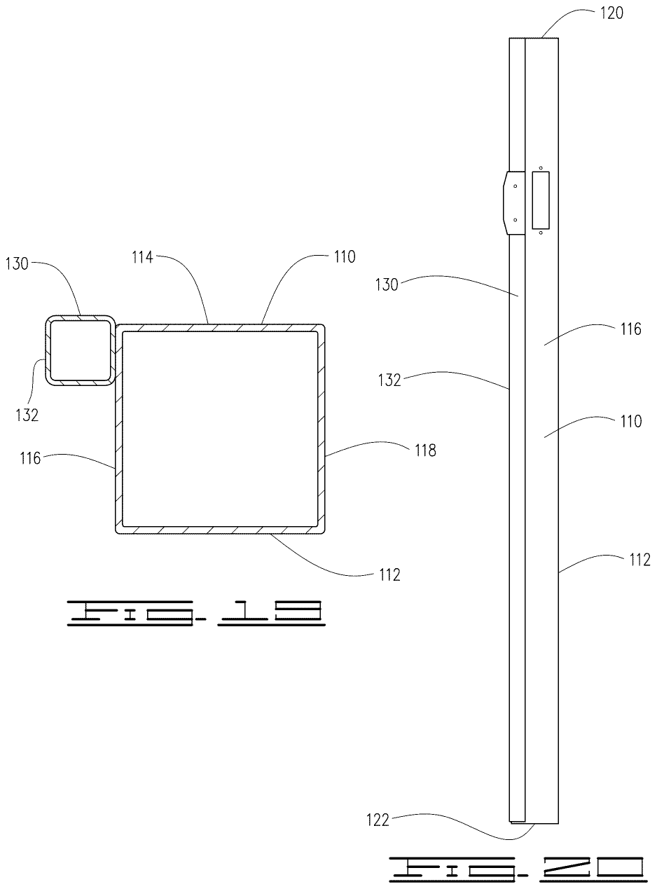

Optionally, a plurality of vertically-spaced fastener openings 134 may be formed in the side section 132 that engages the lower door 100, as shown in FIGS. 17 and 18. Silencer pads (not shown) may be attached to the stop 130 at the fastener openings 134, in order to cushion the lower door 100 and reduce noise at closure. Three such fastener openings 134 are provided in the embodiment shown in the Figures.

The sections 132 should be formed from a strong and durable material, such as steel or aluminum. Suitable steels include pre-galvanized steel and stainless steel. In one embodiment, each of the sections 132 is square tubing having a 1-inch side, and is formed from 14-gauge sheet steel. Each section 132 projects 0.125 inches outside the footprint of the lower jamb 98, and has a length of 50 inches.

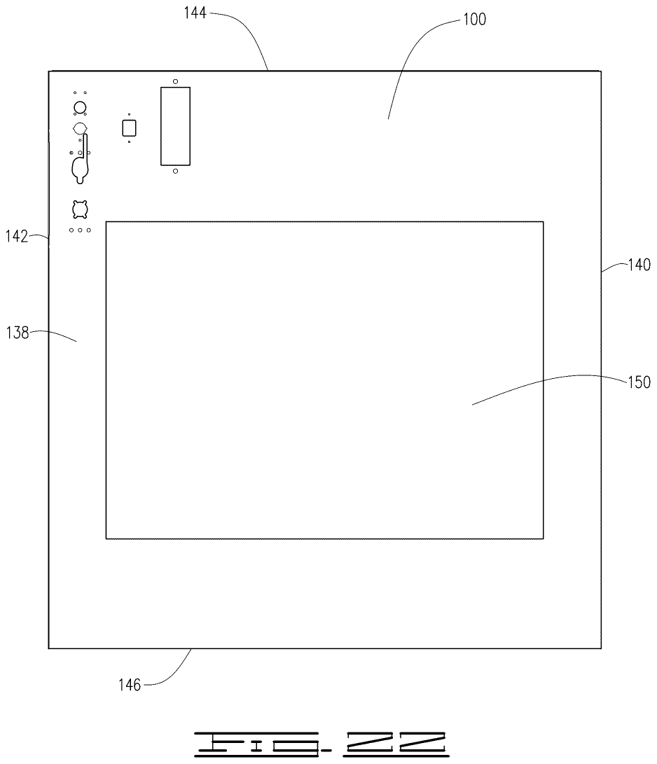

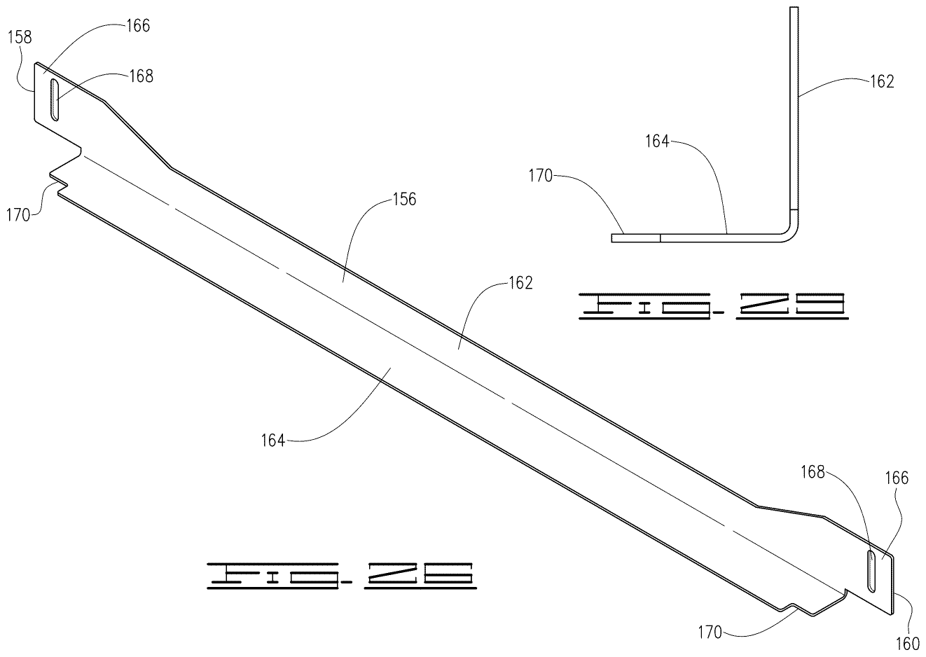

The lower door 100, shown in FIGS. 21-25, is a rectangularly-shaped structure sized to be closely but clearingly received within the lower entryway 106. It has a front side 136, a parallel and opposed rear side 138, an upright hinge side 140, a parallel and opposed latch side 142, an upper side 144, and a parallel and opposed lower side 146. As shown in the Figures, the sides 140 and 142 join the sides 136 and 138, while the sides 136, 138, 140 and 142 join the sides 144 and 146.

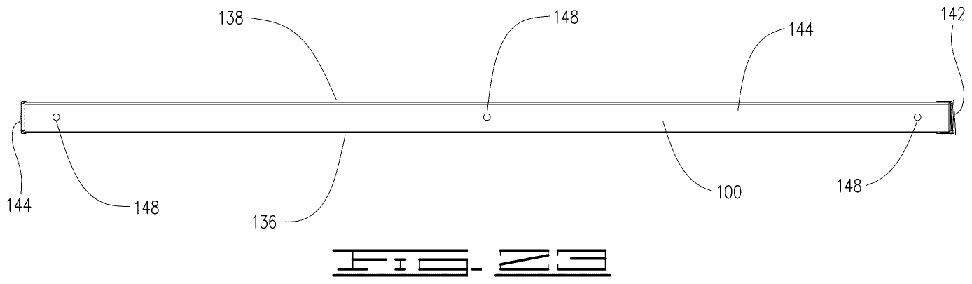

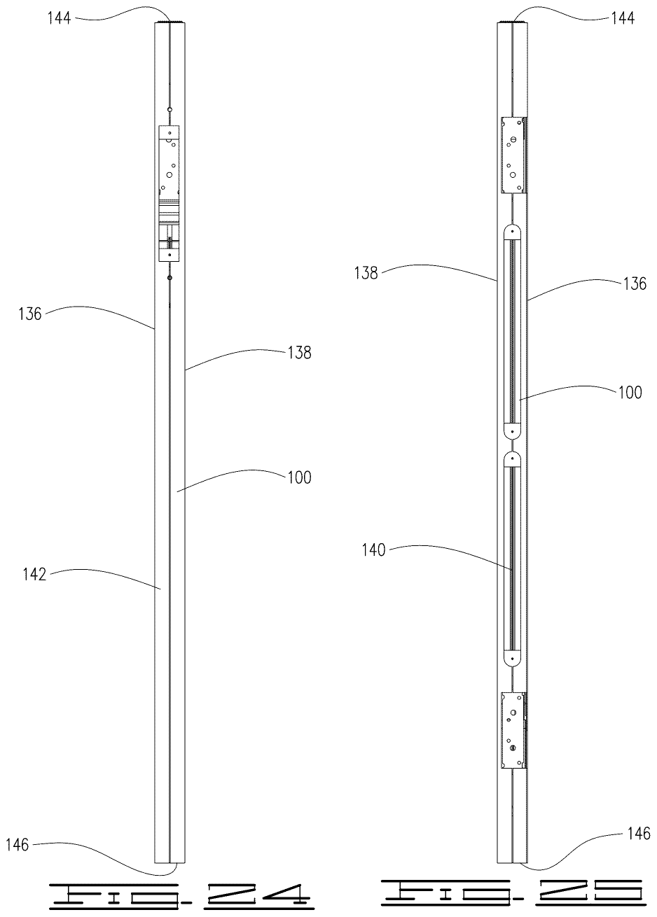

As shown in FIG. 23, a plurality of fastener openings 148, preferably collinear, are formed in the lower door 100 at its upper side 144. In addition, as shown in FIGS. 21 and 22, at least one, and preferably only one window opening 150 is formed in the lower door 100, extending between the sides 136 and 138. A modular and removable window panel 152 is preferably installed in each such window opening 150, as shown in FIGS. 1, 2 and 34-36. The window panel 152 is preferably fitted with a barrier-type infill material.

The lower door 100 is preferably equipped with latching and lock systems (not shown).

The lower door 100 should be formed from a strong and durable material, such as steel or aluminum. Suitable steels include pre-galvanized steel and stainless steel. In one embodiment, the lower door 100 is formed from 14-gauge galvanized steel and has a width of 47.81 inches, a height of 50 inches, and a thickness of 1.79 inches. The single window opening 150 has a width of 37.81 inches and a height of 27.44 inches. The fastener openings 148 are three in number, with a separation distance of 20 inches between adjacent openings.

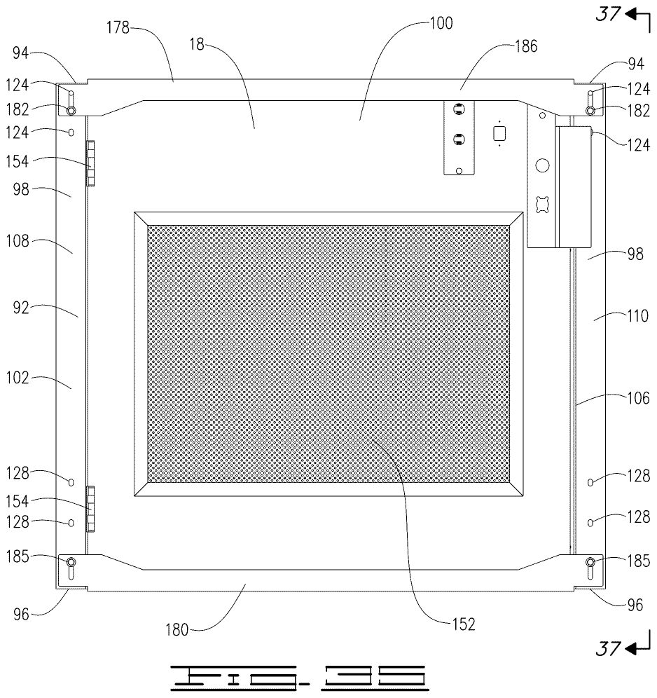

The lower door 100 is positioned within the lower entryway 106 such that the hinge side 140 faces the inner side 116 of the first standing section 108, and such that the latch side 142 faces the inner side 116 of the second standing section 110. Adjacent the hinge side 140, a plurality of hinges 154, shown in FIGS. 34 and 35, effect pivotal attachment of the lower door 100 to the first standing section 108. The hinges 154 are interposed between the lower door 100 and the standing section 108 and partially project from the front side 12 of the entry device 10. In the embodiment shown in the Figures, two such hinges 154 are provided.

The hinges 154 permit the lower door 100 to swing between a closed position, shown in FIGS. 34-36, and an open position (not shown). In its closed position, the lower door 100 is fully situated within the lower entryway 106. In its open position, much or all of the lower door 100 is positioned outside the lower entryway 106, so that individuals and other traffic may traverse the barrier within which the entry device 10 is installed.

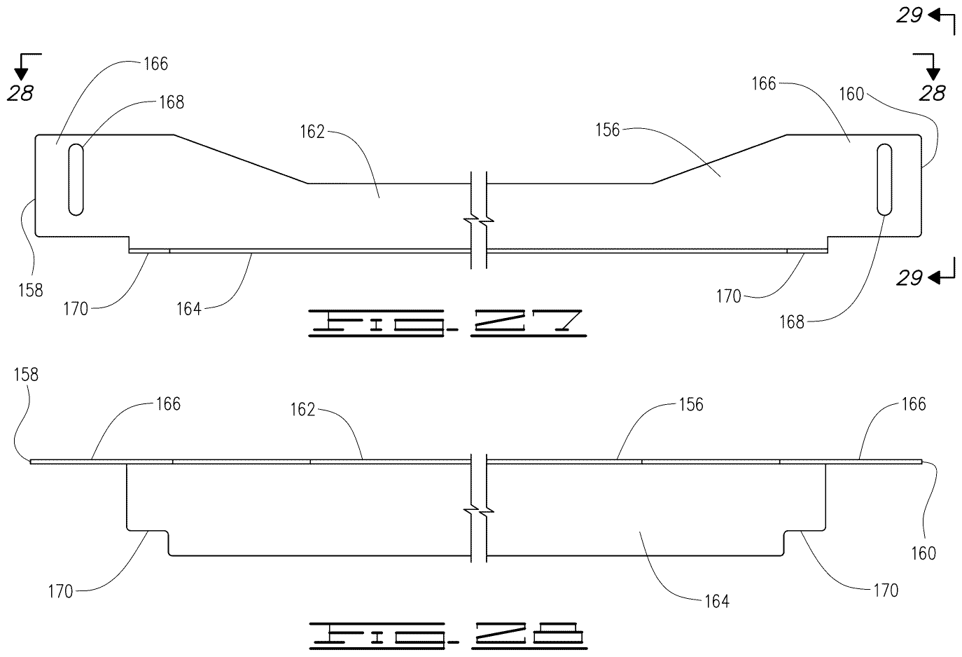

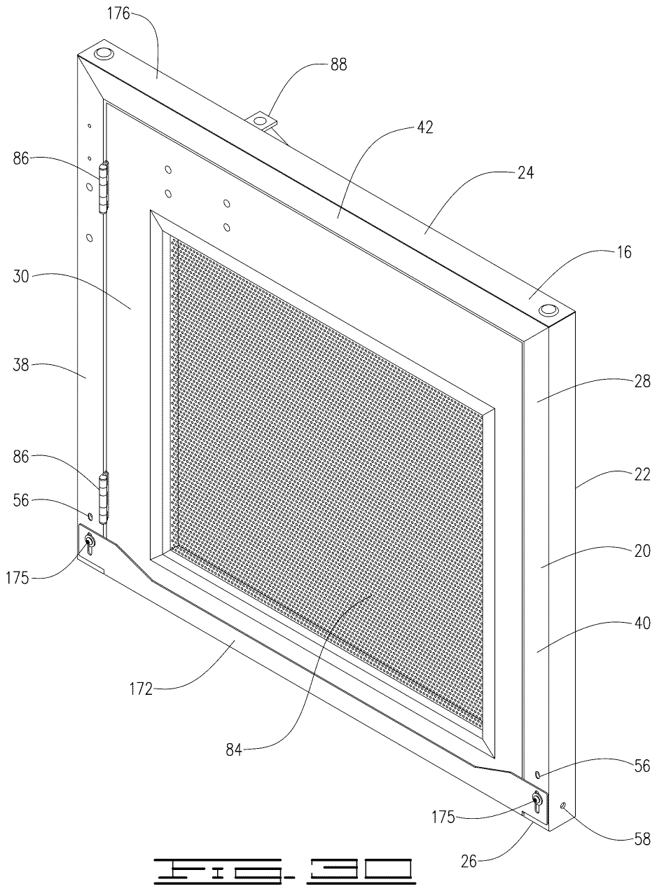

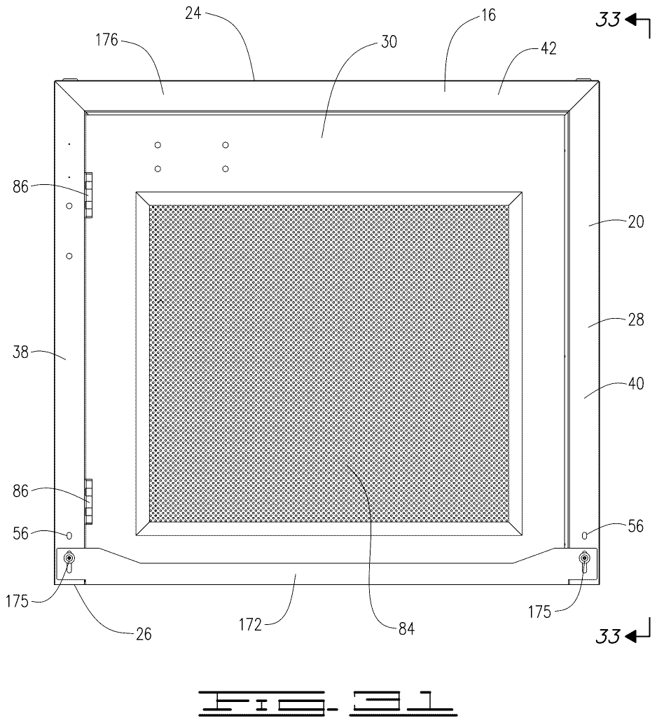

One or more door positioning pieces are used to temporarily join the first and second standing sections 108 and 110 of the lower jamb 98, and to maintain each of the doors 30 and 100 within their respective entryways 36 and 106 during transport and assembly of the entry device 10. One such door positioning piece 156 is shown in FIGS. 26-29.

The door positioning piece 156 is an elongate, rigid and unitary member having a first end 158 and an opposed second end 160. It is formed from a flat and elongate bridge section 162, which is joined to a flat base section 164. Intermediate its ends 158 and 160, the door positioning piece 156 has the cross-sectional shape of the letter “L.”

The bridge section 162 is configured to join the first and second standing sections of a jamb, as well as to engage the door situated between those standing sections. The base section 164 is shorter than the bridge section 162 and extends in orthogonal relationship thereto. It is configured to clear the first and second standing sections of a jamb and to engage only the door situated between those standing sections.

Adjacent the ends 158 and 160, the bridge section 162 forms a pair of flat projecting tabs 166. A fastener opening 168 is formed in each such tab 166. A notch 170 is cut out of each end of the base section 164.

The door positioning piece 156 should be formed from a strong and durable material, such as steel or aluminum. Suitable steels include pre-galvanized steel and stainless steel. In one embodiment, the door positioning piece 156 is formed from A36 steel having a thickness of 0.13 inches. The bridge section 162 has a maximum length of 53.88 inches and a maximum height of 3.63 inches. The base section 164 has a maximum length of 48.13 inches and a maximum depth of 2.88 inches.

FIGS. 30-33 illustrate assembly of a door positioning piece 172 with an upper entry component 16. The piece 172 is preferably identical to the door positioning piece 156.

The base section 164 of the piece 172 is placed in face-to-face engagement with the lower side 26 of the upper entry component 16, and each tab 166 is placed in face-to-face engagement with the front side 20 of that upper entry component 16.

Each tab 166 should engage a corresponding one of the standing sections 38 and 40. The assembly is adjusted, if necessary, such that each fastener opening 168 is aligned with a corresponding one of the fastener openings 56. With the fastener openings 168 and 56 thus aligned, a fastener is inserted into each set of aligned openings.

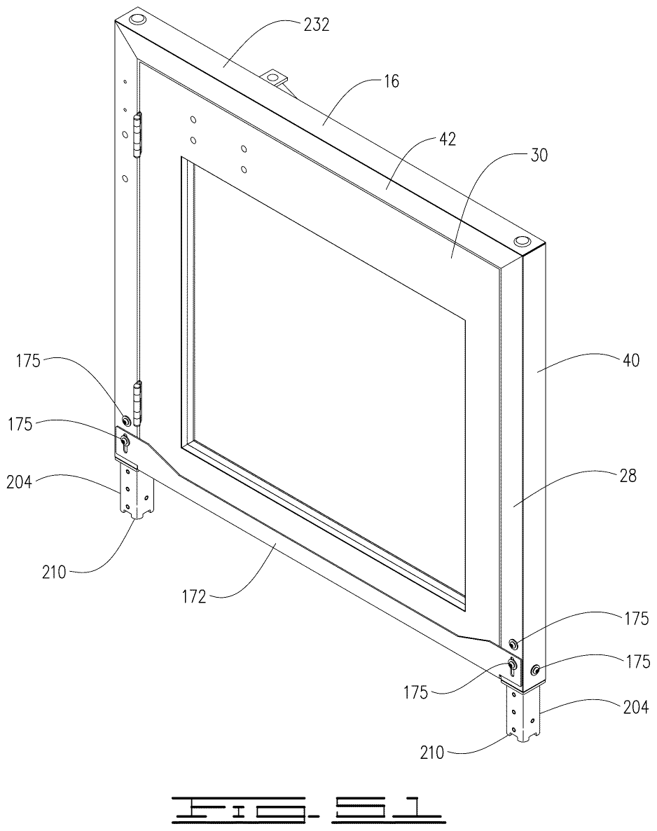

The fastener is initially a temporary fastener 174, shown in FIG. 50, which passes through the entirety of the standing section into which it is installed. During later stages of assembly, the temporary fastener 174 will be replaced with a shorter permanent fastener 175, shown in FIGS. 30-33. Although not shown in the Figures, permanent fasteners 175 are also installed in the remaining unoccupied fastener openings 56 and 58. The resulting structure 176 is shown in FIGS. 30-33.

The door positioning piece 172 is adapted to concurrently engage, and does concurrently engage, both the front side 20 and the lower side 26 of the upper entry component 16. It engages the front side 20 at each of the first and second standing sections 38 and 40 and at the upper door 30 as well. It engages the lower side 26 at the upper door 30 and not at either of the standing sections 38 and 40. The upper door 30 is thereby confined within the upper entryway 36, with the stop 60 blocking opening toward the rear side 70, and the piece 172 blocking opening toward the front side 68.

Because of the differing lengths of the base section 164 and the bridge section 162, the base section 164 can engage the upper door 30 without blocking the standing sections 38 and 40, which remain accessible for assembly with the standing sections 108 and 110, as will be described hereafter. The bridge section 162, on the other hand, engages the standing sections 38 and 40 and the upper door 30 as well, as required for effective confinement of the upper door 30.

At the same time that it performs the foregoing functions, the door positioning piece 172 also assists, in cooperation with the header section 42, in rigidly linking the first and second standing sections 38 and 40. Such linkage helps to assure that the relative positions of the upper jamb 28 and upper door 30, which may have required precise fine-tuning at the factory, will be maintained during transport and storage of the disassembled entry device 10 in the field.

FIGS. 34-37 illustrate assembly of a pair of lower door positioning pieces 178 and 180 with a lower entry component 18. Each of the pieces 178 and 180 is preferably identical to the door positioning piece 156.

The base section 164 of the piece 178 is placed in face-to-face engagement with the upper side 94 of the lower entry component 18, and each tab 166 is placed in face-to-face engagement with the front side 90 of that lower entry component 18. Each tab 166 should engage a corresponding one of the standing sections 108 and 110. The assembly is adjusted, if necessary, such that each fastener opening 168 is aligned with a corresponding one of the fastener openings 124. With the fastener openings 168 and 124 thus aligned, a fastener is inserted into each set of aligned openings.

The fastener is initially a temporary fastener (not shown), identical to the fastener 174. The temporary fastener passes through the entirety of the standing section into which it is installed. During later stages of assembly, the temporary fastener will be replaced with a shorter permanent fastener 184, shown in FIGS. 34-37. Although not shown in the Figures, permanent fasteners 184 are also installed in the remaining unoccupied fastener openings 124 and 126.

The base section 164 of the piece 180 is placed in face-to-face engagement with the lower side 96 of the lower entry component 18, and each tab 166 is placed in face-to-face engagement with the front side 90 of that lower entry component 18. Each tab 166 should engage a corresponding one of the standing sections 108 and 110. The assembly is adjusted, if necessary, such that each fastener opening 168 is aligned with a corresponding one of the fastener openings 128. With the fastener openings 168 and 128 thus aligned, a fastener is inserted into each set of aligned openings.

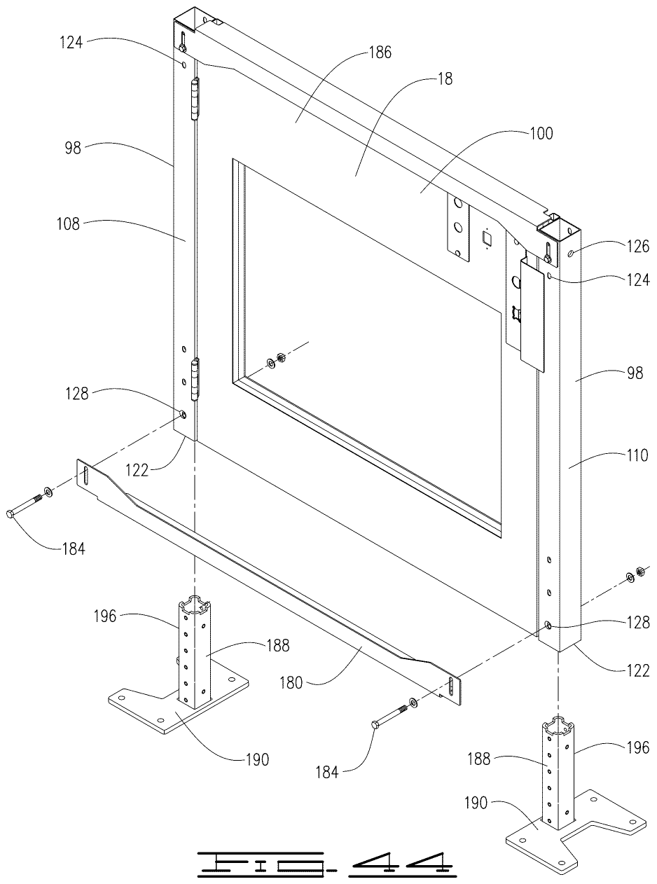

The fastener is initially a temporary fastener 184, shown in FIG. 44, which passes through the entirety of the standing section into which it is installed. During later stages of assembly, the temporary fastener 184 will be replaced with a shorter permanent fastener 185, shown in FIGS. 34-37. Although not shown in the Figures, permanent fasteners 185 are also installed in the remaining unoccupied fastener openings 128. The resulting structure 186 is shown in FIGS. 34-37.

Each door positioning piece 178 and 180 is adapted to concurrently engage, and does concurrently engage, both the front side 90 and either the upper side 24 or the lower side 26 of the upper entry component 16. In the embodiment shown in the Figures, door positioning piece 178 engages the upper side 24, while door positioning piece 180 engages the lower side 26. The lower door 100 is thereby confined within the lower entryway 106, with the stop 130 blocking opening toward the rear side 104, and the pieces 178 and 180 blocking opening toward the front side 102.

Because of the differing lengths of the base section 164 and bridge section 162, the base section 164 of the door positioning piece 178 can engage the lower door 100 without blocking the standing sections 108 and 110, which remain accessible for assembly with the standing sections 38 and 40, as will be described hereafter. The bridge section 162, on the other hand, engages the standing sections 108 and 110 and the lower door 100 as well, as required for effective confinement of the lower door 100.

The base section 164 of the door positioning piece 180 can likewise engage the lower door 100 without blocking the standing sections 108 and 110, which remain accessible for assembly with footings, as will be described hereafter. The bridge section 162, on the other hand, engages the standing sections 108 and 110 and the lower door 100 as well, as required for effective confinement of the lower door 100.

At the same time that they perform the foregoing functions, the door positioning pieces 178 and 180 also rigidly link the first and second standing sections 108 and 110. Such linkage helps to assure that the relative positions of the lower jamb 98 and lower door 100, which may have required precise fine-tuning at the factory, will be maintained during transport and storage of the disassembled entry device 10 in the field.

After each of the upper and lower entry components 16 and 18 has been assembled and the door positioning pieces 172, 178 and 180 installed, the next stage of assembly involves installation of footings 188 on the lower entry component 18. The footings 188 permit the lower entry component 18, and thus the entry device 10, to stand without external bracing or support.

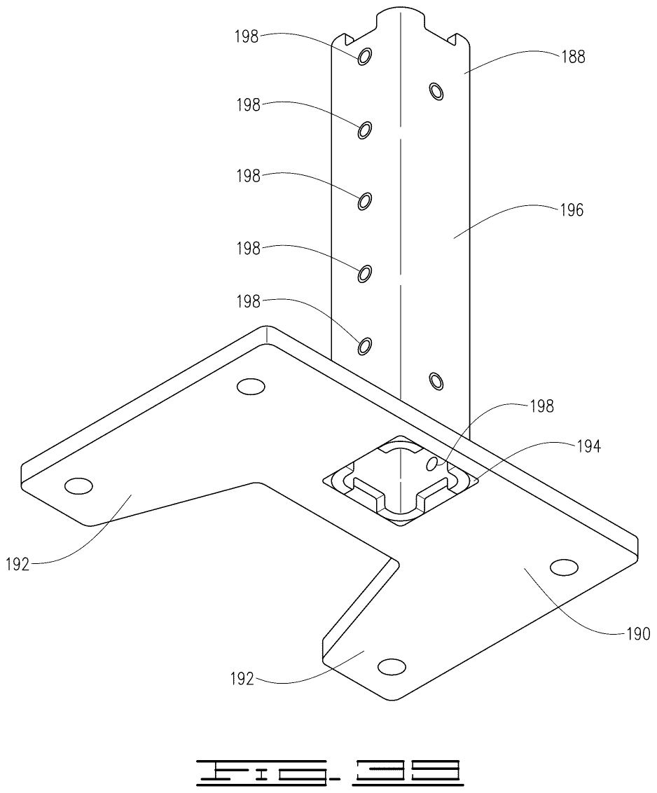

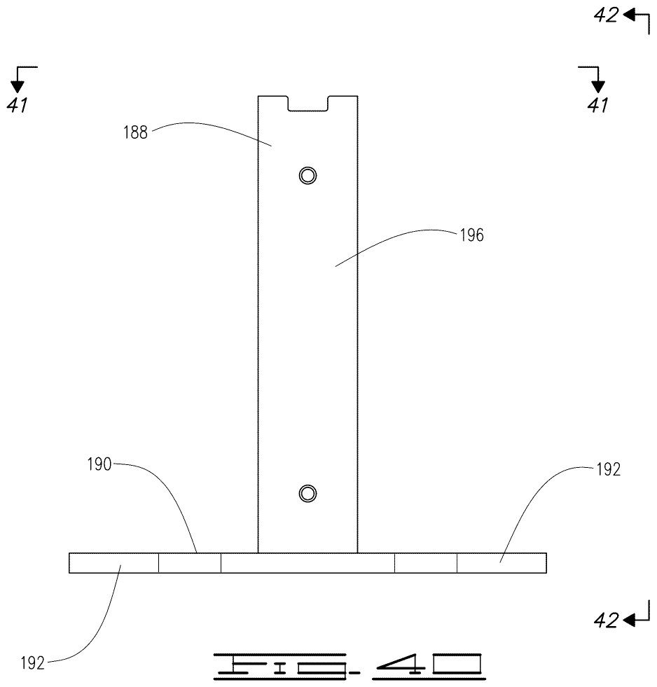

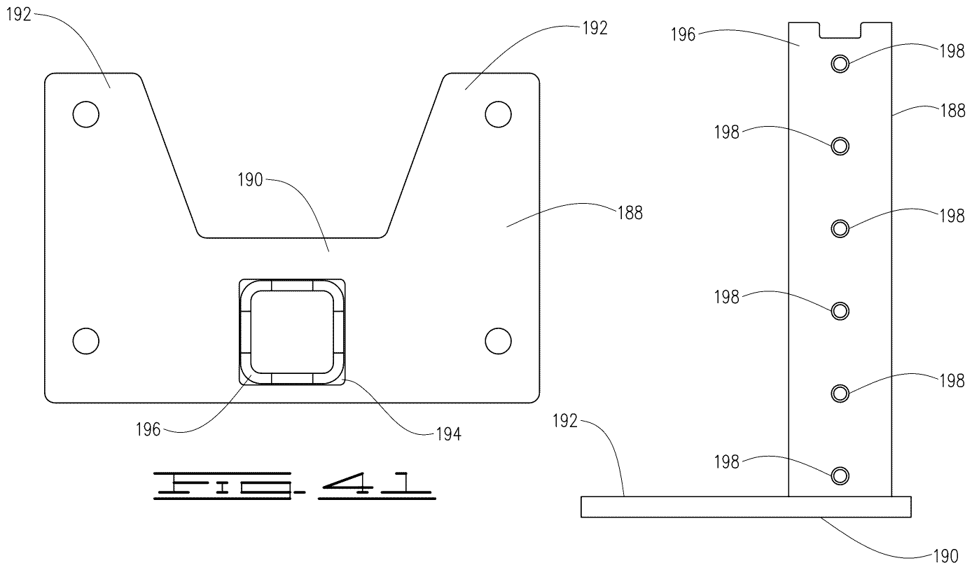

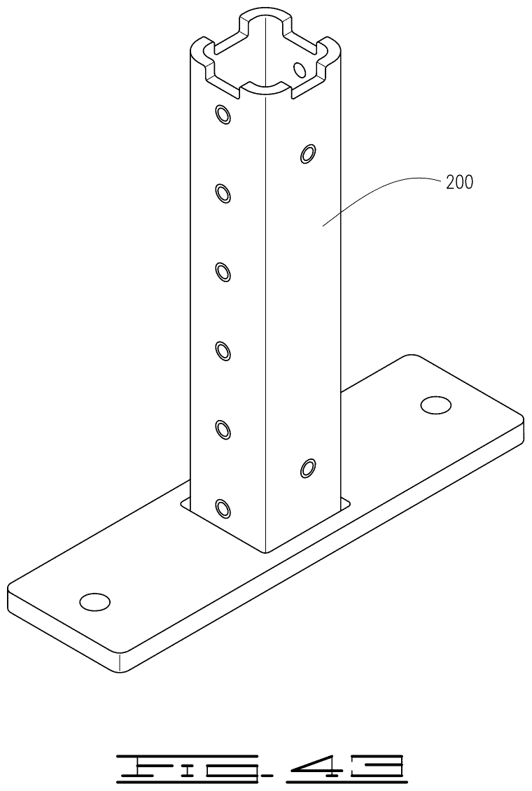

The footing 188, shown in FIGS. 38-42, comprises a flat, enlarged and ground-engaging base 190. The shape of the base 190 is splayed, and marked by two diverging lobes 192. Within its interior, the base 190 is penetrated by an opening 194, within which one end of a compact and projecting tower 196 is received. One end of the tower 196 is permanently secured within the opening 194, preferably by welding.

The tower 196 is an elongate, rigid and rectilinear structure that projects orthogonally from one and only one side of the base 190. The tower's external size and shape closely conform to the internal size and shape of the lower end 122 of each of the standing sections 108 and 110. This near-matching of sizes and shapes permits each tower 196 to be closely, clearingly and telescopingly received within a hollow lower end 122.

Each tower 196 has a front side and an opposed rear side. In each of these sides, the tower 196 is provided with a longitudinally-spaced series of fastener openings 198. The fastener openings 198 in each side are preferably collinear, and aligned with the fastener openings 198 formed in the opposite side. When the tower 196 is received within the lower end 122 of a standing section 108 or 110, the fastener openings 198 should register with the fastener openings 128.

The footing 188 should be formed from a strong and durable material, such as steel or aluminum. Suitable steels include pre-galvanized steel and stainless steel. In one embodiment, the base 190 and tower 196 are both formed from A36 steel. The base 190 has a thickness of 0.5 inches, a maximum width of 8 inches and a maximum length of 12 inches. The tower 196 is formed from square tubing having a thickness of 0.25 inches, a side of 2.5 inches and a maximum length of 12 inches. Six fastener openings 198 are formed in the tower 196, with a separation distance of 2 inches between adjacent openings.

Another embodiment of a footing is shown in FIG. 43. The footing 200 is identical in all respects to the footing 188 except for the shape of its base, which is rectangular and unsplayed. The more compact base shape of the footing 200 may make it more suitable for use in areas where floor space is limited. In one embodiment, the footing 200 has a rectangular shape with a major side of 12 inches and a minor side of about 3 inches.

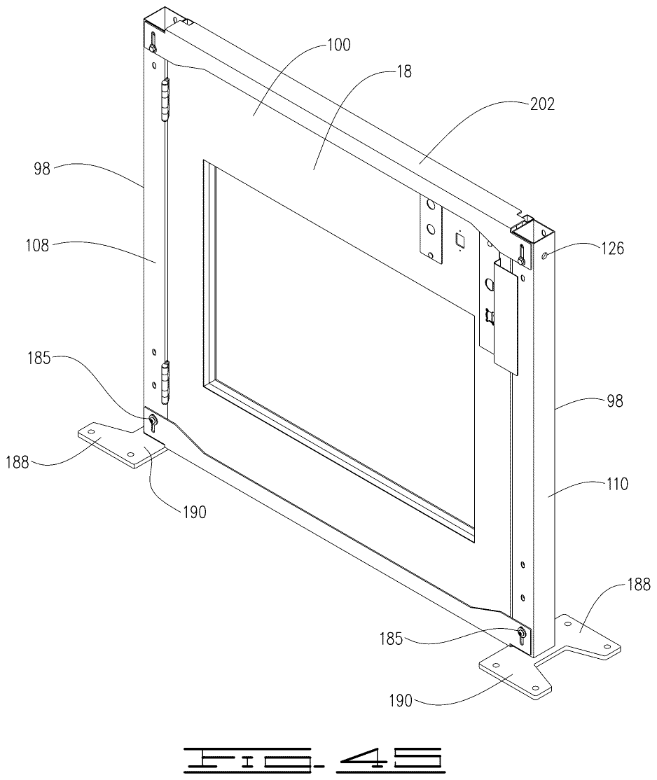

FIG. 44 illustrates assembly of footings 188 with the structure 186 shown in FIGS. 34-37. Temporary fasteners 184 are first removed from the structure, thereby unblocking the hollow lower ends 122 of the standing sections 108 and 110. The door positioning piece 180, now loose, is temporarily set aside. The towers 196 of two footings 188 are next inserted into the lower ends 122 of the first and second standing sections 108 and 110, in a one-to-one relationship. The door positioning piece 180 is now reinstalled, and the fastener openings 168, 128 and 198 aligned. A permanent fastener 185 is inserted into each set of aligned openings. The resulting structure 202 is shown in FIG. 45.

After footings 188 have been installed on the lower entry component 18, the base 190 of each footing 188 is preferably bolted to flat flooring. Openings within the base 190 are used to effect such bolting.

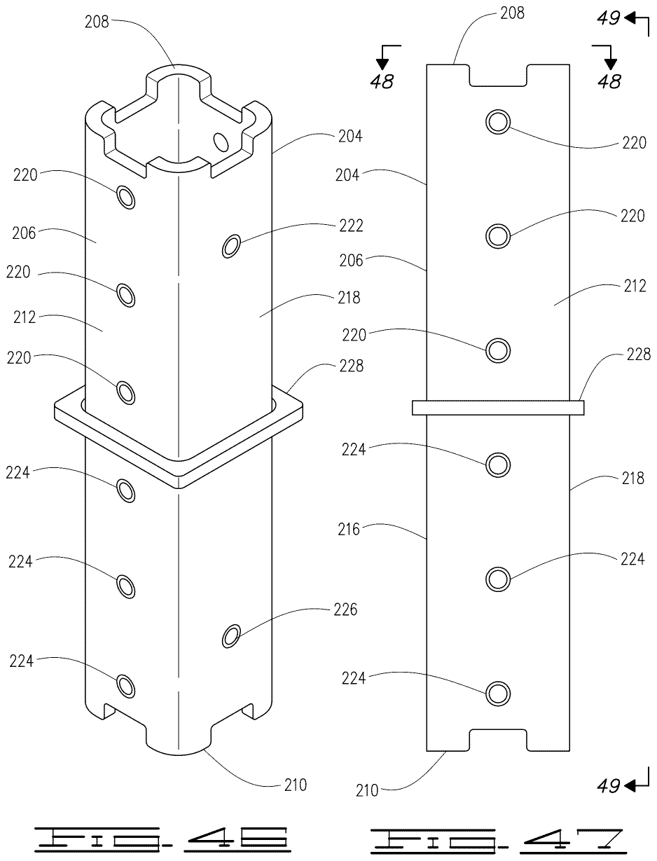

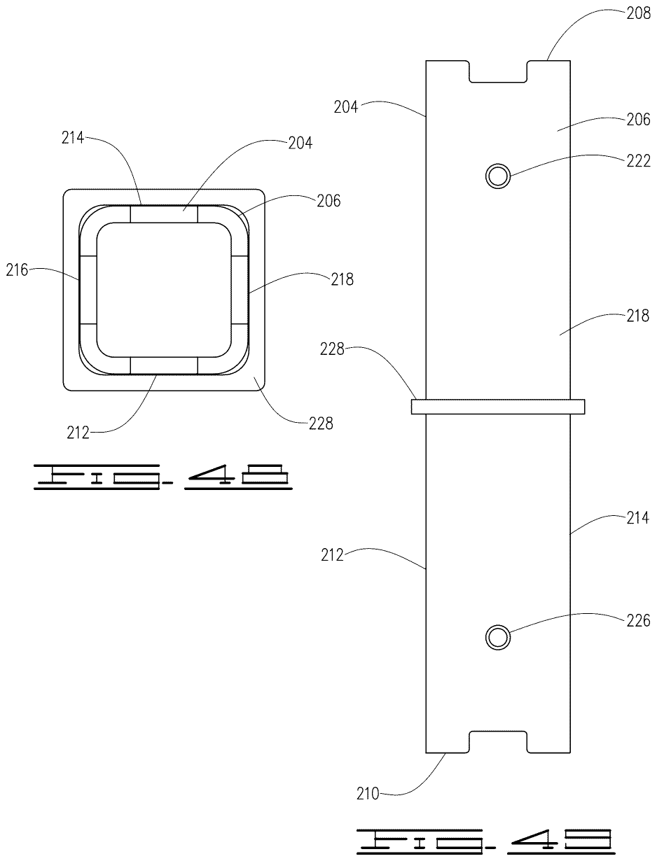

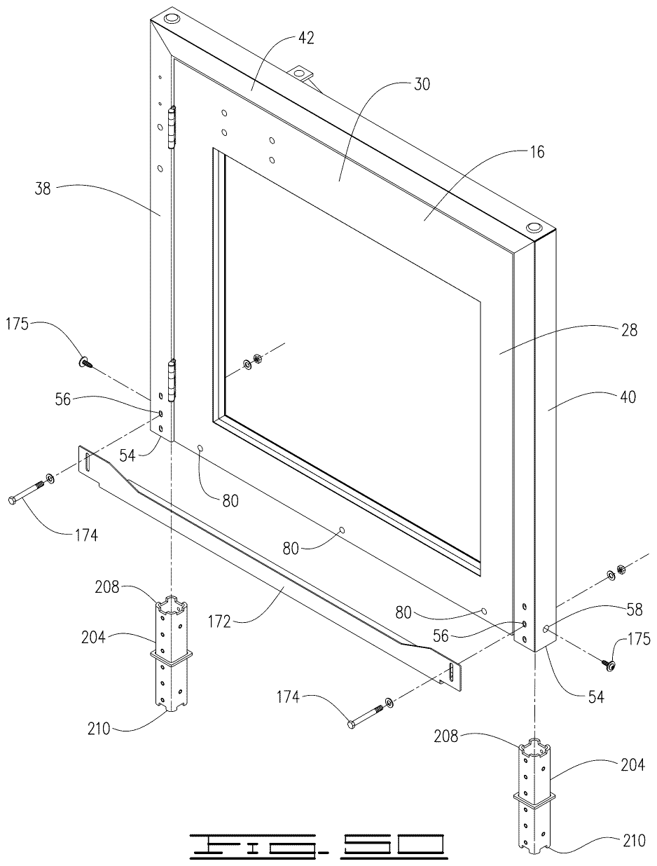

In the next stage of assembly, the lower entry component 18, now bolted to a floor, is joined to the upper entry component 16. Splicing elements 204, one of which is shown in FIGS. 46-49, are used to effect this assembly.

The splicing element 204 comprises an elongate, rigid and rectilinear body 206 of preferably tubular construction and having a first end 208 and an opposed second end 210. At its ends, the body 206 is preferably castellated. Between its ends, the body 206 has an external size and shape that closely conform to the internal size and shape of the lower end 54 of each standing section 38 and 40, and the upper end 120 of each standing section 108 and 110. These near-matching sizes and shapes permit the body 206 to be closely, clearingly and telescopingly received within the hollow ends 54 and 120 of the standing sections.

The body 206 preferably has a rectangular, and more preferably square, cross-sectional shape, with a front side 212, a parallel and opposed rear side 214, a left side 216 and a parallel and opposed right side 218. The sides 216 and 218 join the sides 212 and 214, and extend in orthogonal relationship thereto.

Adjacent its first end 208, the body 206 is provided with a longitudinally-spaced first series of fastener openings 220 in each of the front and rear sides 212 and 214. The fastener openings 220 in each side are preferably collinear, and aligned with the fastener openings 220 formed in the opposite side. Also adjacent its first end 208, the body 206 is provided with at least one, and preferably only one fastener opening 222 in each of the left and right sides 216 and 218.

Adjacent its second end 210, the body 206 is similarly provided with a longitudinally-spaced second series of fastener openings 224 in each of the front and rear sides 212 and 214. The fastener openings 224 in each side are preferably collinear, and aligned with the fastener openings 224 formed in the opposite side. The fastener openings 224 in each side are likewise collinear with the fastener openings 220 formed in that side. Preferably, the fastener openings 220 and 224 are equal in number.

Also adjacent its second end 210, the body 206 is provided with at least one, and preferably only one fastener opening 226 in each of the left and right sides 216 and 218.

When the splicing element 204 is received within the lower end 54 of a standing section 38 or 40, the fastener openings 220 should register with the fastener openings 56, and the fastener opening 222 should register with the fastener opening 58. Similarly, when the splicing element 204 is received within the upper end 120 of a standing section 108 or 110, the fastener openings 224 should register with the fastener openings 124, and the fastener opening 226 should register with the fastener opening 126.

The splicing element 204 further comprises a circumferential skirt 228 that surrounds the body 206 and is situated between its first and second ends 208 and 210. Preferably, the skirt 228 is situated at the midpoint between the ends 208 and 210, and is permanently secured to the body 206, preferably by welding.

The maximum transverse dimension of the skirt 228 should exceed the maximum transverse dimension of the lower end 54 of each standing section 38 and 40, and the upper end 120 of each standing section 108 and 110. These relative dimensions cause the skirt 228 to engage the end of any standing section into which the splicing element 204 is inserted, thereby preventing it from falling into the standing section. The fastener openings 220 and 224 are situated on opposite sides of the skirt 228.

The splicing element 204 should be formed from a strong and durable material, such as steel or aluminum. Suitable steels include pre-galvanized steel and stainless steel. In one embodiment, the body 206 and skirt 228 are both formed from A36 steel having a thickness of 0.25 inches. The body 206 is formed from square tubing having a side of 2.5 inches and a maximum length of 12 inches. Three fastener openings 220 and three fastener openings 224 are formed in the body 206. The separation distance between adjacent openings is 2 inches. In the same embodiment, the skirt 228 is an annular square with an inner side of 2.52 inches and an outer side of 3 inches. FIG. 50 illustrates assembly of two splicing elements 204 with the structure 202 shown in FIG. 45. The fasteners 174 that secure the door positioning piece 172 to the structure 202 are first removed, thereby unblocking the hollow lower ends 54 of the standing sections 38 and 40. The door positioning piece 172, now loose, is temporarily set aside.

The first ends 208 of splicing elements 204 are next inserted into the lower ends 54 of the standing sections 38 and 40 of structure 202, in a one-to-one relationship. The upper door positioning piece 172 is next reinstalled on the assembly. Fastener openings 168, 56 and 220 are aligned, a fastener 174 reinserted into each aligned set of openings, and the fasteners 174 actuated. Fastener openings 58 and 222 are also aligned, and a fastener 230 inserted into each set of aligned openings. The resulting structure 232 is shown in FIG. 51.

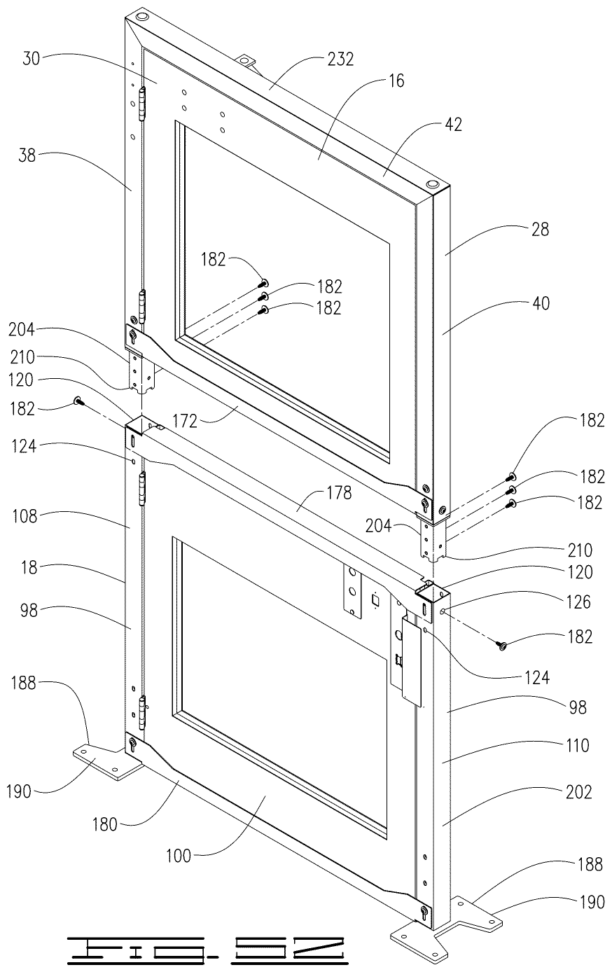

FIG. 52 illustrates assembly of the structure 232 shown in FIG. 51 with the structure 202 shown in FIG. 45. The fasteners 182 that secure the door positioning piece 178 to the structure 202 are first removed, thereby unblocking the hollow upper ends 120 of the standing sections 108 and 110. The door positioning piece 178 is left in place.

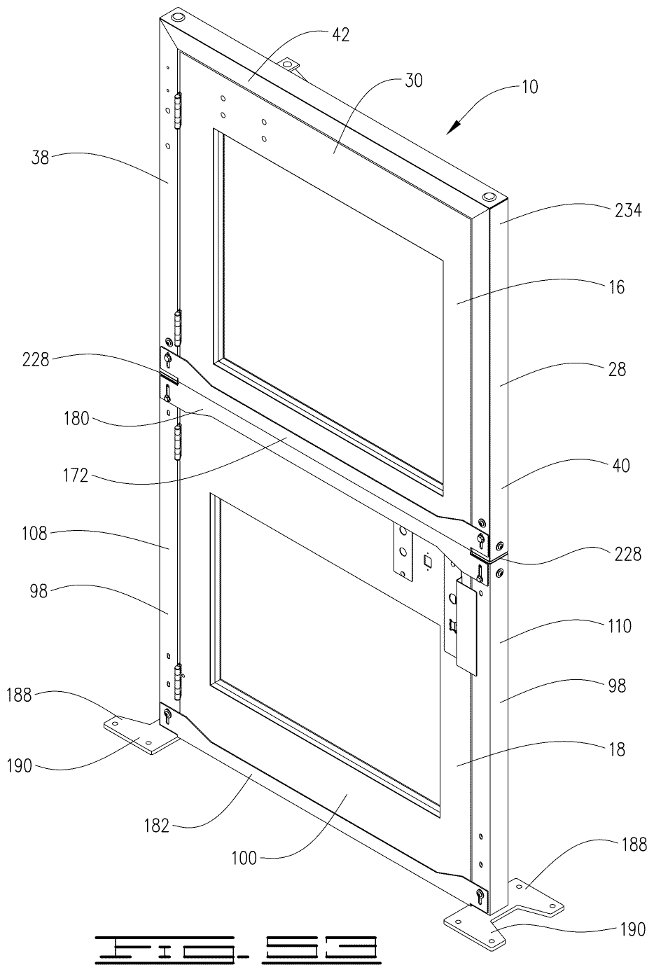

The structure 232 is next lowered onto the structure 202 such that the second ends 210 of the splicing elements 204 enter the hollow upper ends 120 of the standing sections 108 and 110, in a one-to-one relationship. Fastener openings 168, 124 and 224 are aligned, and a fastener 182 inserted into each aligned set of openings. Fastener openings 126 and 226 are also aligned, and a fastener 230 inserted into each set of aligned openings. The resulting structure 234 is shown in FIG. 53.

As shown in FIG. 53, the skirt 228 of a splicing element 204 is sandwiched between the aligned and connected standing sections 38 and 108, and the skirt 228 of another splicing element 204 is sandwiched between the aligned standing sections 40 and 110.

The door positioning pieces 172, 178 and 180 are next removed, and the permanent fasteners 175, 184 and 185 that held them in place are reinstalled. All permanent fasteners 175, 184 and 185 are next adjusted as needed to produce a sound fit between each door and its associated jamb. These fasteners are then tightened to produce a final configuration of the entry device 10. The fully assembled entry device 10 is shown in FIGS. 1-3.

As a result of the foregoing steps, the upper and lower entry components 16 and 18 are assembled with one another using two splicing elements 204. One of these splicing elements 204 joins the aligned first standing sections 38 and 108 of the upper and lower jambs 28 and 98. The other of these splicing elements 204 joins the aligned second standing sections 40 and 110 of the same jambs. Each splicing element 204 is concurrently receivable, and received, within the hollow end of a standing section of the upper jamb 28, and within the hollow end of a standing section of the lower jamb 98.

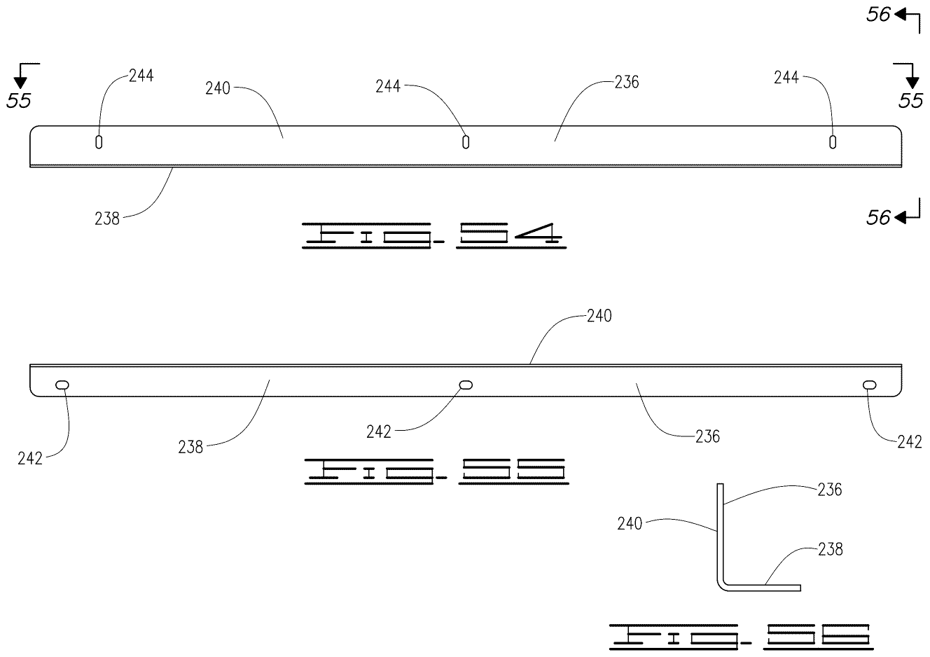

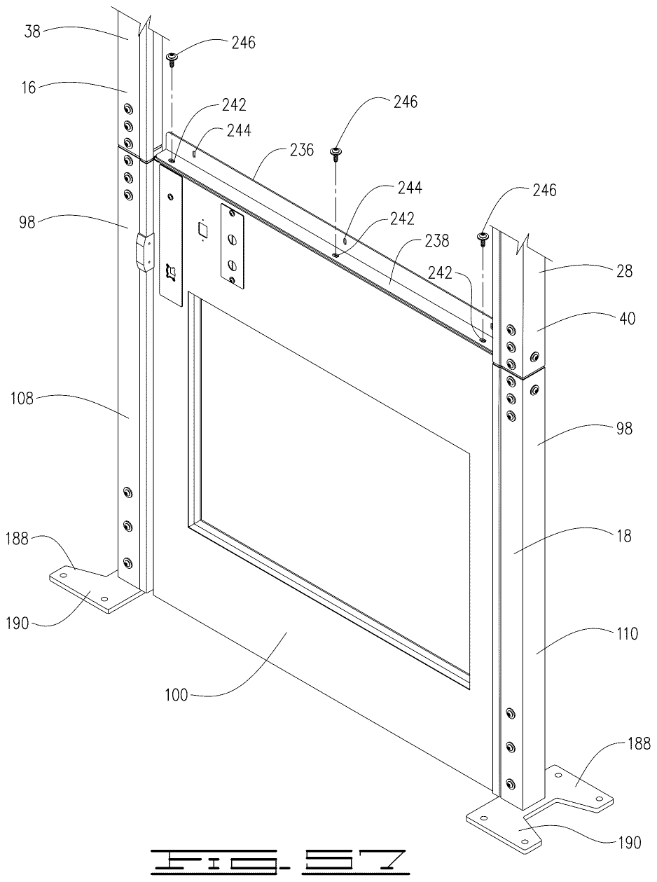

In many instances, it will be desirable that the upper and lower doors 30 operate as a unit, rather than separately and independently. To this end, a door connection bracket 236, shown in FIGS. 54-56, can be used to removably and rigidly join the upper and lower doors 30 and 100. The bracket 236 is an elongate, rigid and unitary member having a flat and rectangular lower leg 238 joined to a flat, rectangular and orthogonal upper leg 240 of equal length. It has the cross-sectional shape of the letter “L.” A plurality of fastener openings 242 are formed in the lower leg 238, and another plurality of fastener openings 244 are formed in the upper leg 240. The fastener openings 242 are preferably collinear, as are the fastener openings 244.

The door connection bracket 236 should be formed from a strong and durable material, such as steel or aluminum. Suitable steels include pre-galvanized steel and stainless steel. In one embodiment, the door connection bracket 236 is galvanized steel having a thickness of 0.13 inches. The legs 238 and 240 are each 47.5 inches in length. The lower leg 238 has a width of 1.75 inches, and the upper leg 240 has a width of 2.25 inches. Each of the legs 238 and 240 has three fastener openings with a separation distance of 20 inches between adjacent openings.

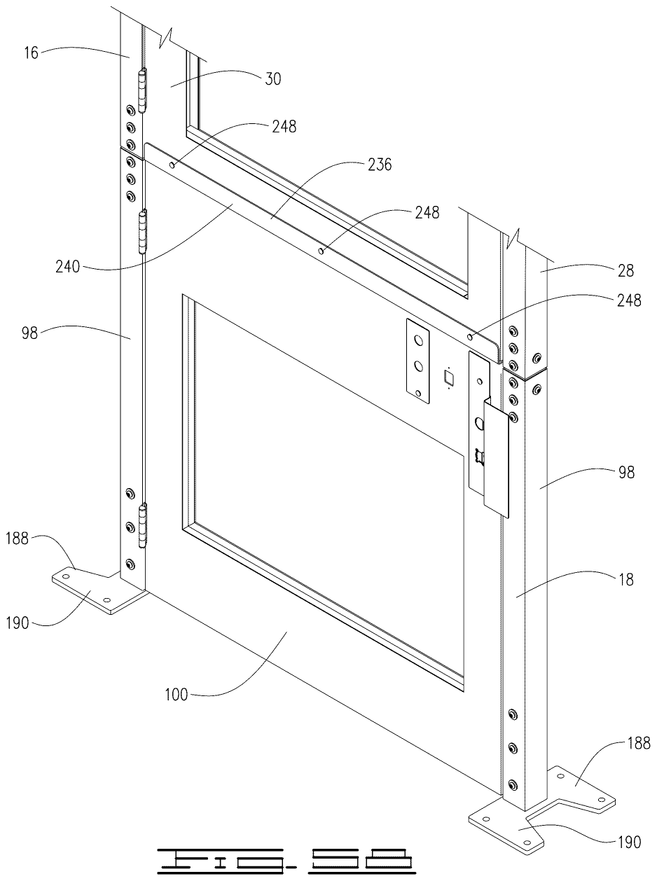

FIG. 57 illustrates assembly of a door connection bracket 236 with the structure 234 shown in FIG. 53. The door positioning pieces 172, 178 and 180 are first removed, if present. The upper door 30 is opened, and the lower leg 238 of the door connection bracket 236 placed in face-to-face engagement with the upper side 144 of the upper door 30. The fastener openings 242 and 148 are aligned, a fastener 246 inserted into each set of aligned openings, and the fasteners 246 actuated.

The upper door 30 is next closed until it establishes face-to-face engagement with the upper leg 240 of the door connection bracket 236. The fastener openings 244 and 80 are aligned, a fastener 248 inserted into each set of aligned openings, and the fasteners 248 actuated. The resulting structure is shown in FIG. 58, as well as in FIGS. 1-3.

Preferably, the upper and lower doors 30 and 100 are “prehung” on their respective jambs 28 and 98 at a manufacturing facility. The door positioning pieces 172, 178 and 180 help to maintain the doors 30 and 100 and jambs 28 and 98 in their factory-optimized relationship during storage, transport and the early stages of installation. As a result, little, if any adjustment between door and jamb is required at the site where the entry device 10 is to be installed.

The two separate entry components 16 and 18 permit the entry device 10 to be installed in environments where space restrictions might render a unitary door impossible to install. The two smaller entry components 16 and 18 can be brought to the installation site separately, without sacrificing the factory fine-tuning that has gone into hanging each door on its jamb. Once on site, these components can be quickly assembled into a complete door using the footings, the splicing elements and the door connection bracket.

The entry device 10 can be conveniently assembled from the components of a kit. At a minimum, such a kit should include an upper entry component 16 and a lower entry component 18. Optionally, the kit may include any one or more of the following: splicing elements 204; door positioning pieces 156; door connection brackets 236; and footings 188 and 200. Other components of the entry device 10 may be included in the kit, as may hardware, such as fasteners, needed for its assembly.

Unless otherwise stated herein, any of the various parts, elements, steps and procedures that have been described should be regarded as optional, rather than as essential. Changes may be made in the construction, operation and arrangement of these parts, elements, steps and procedures without departing from the spirit and scope of the invention as described in the following claims.

1. A kit, comprising:
an upper entry component, comprising:
an upper jamb formed from three sections that cooperate to define boundaries of an upper entryway, the sections comprising:
a first standing section;
a second standing section extending parallel to the first standing section; and
a header section that permanently interconnects the first and second standing sections; and
a swinging upper door pivotally attached to the first standing section and positionable within the upper entryway; and
a lower entry component assemblable with, but disassembled from, the upper entry component, comprising:
a lower jamb formed from two sections that cooperate to define boundaries of a lower entryway, the sections comprising:
a first standing section; and
a second standing section extending parallel to the first standing section; and
a swinging lower door pivotally attached to the first standing section and positionable within the lower entryway.

2. The kit of claim 1 in which the first standing sections of the upper and lower jambs are assemblable with one another, and the second standing sections of the upper and lower jambs are assemblable with one another.

3. The kit of claim 2 in which the first standing sections of each of the upper and lower jambs is characterized by a hollow end, and further comprising:
a splicing element having a first end telescopingly receivable within the hollow end of the first standing section of the upper jamb, and an opposed second end concurrently and telescopingly receivable within the hollow end of the first standing section of the lower jamb.

4. The kit of claim 3 in which each splicing element further comprises a circumferential skirt situated between its first and second ends.

5. The entry device of claim 1, further comprising:
an elongate and rigid door connection bracket that removably joins the upper and lower doors.

6. The kit of claim 5 in which door connection bracket has the cross-sectional shape of the letter “L.”7. The kit of claim 1 in which the lower jamb has no rectilinear structure that permanently joins the first and second standing sections.

8. The kit of claim 1 in which the first and second standing sections of the lower jamb are joined by at least one elongate, rigid and removable door positioning piece.

9. The kit of claim 8 in which each door positioning piece comprises:
a flat and elongate bridge section configured to join the first and second standing sections of the lower jamb; and
a flat base section, shorter than the bridge section and configured to clear the first and second standing sections of the lower jamb and engage only the lower door, the base section being joined to the bridge section and extending in orthogonal relationship thereto.

10. The kit of claim 1 in which the first standing section of the lower jamb is characterized by a hollow end, and further comprising:
a footing having a flat, enlarged and ground-engagable base that supports a compact and projecting tower, the tower receivable within the hollow end of the first standing section of the lower jamb.

11. An entry device, comprising:
an upper entry component, comprising:
an upper jamb formed from three sections that cooperate to define boundaries of an upper entryway, the sections comprising:
a first standing section;
a second standing section extending parallel to the first standing section; and
a header section that permanently interconnects the first and second standing sections; and
a swinging upper door pivotally attached to the first standing section and positionable within the upper entryway;
a lower entry component formed separately from the upper entry component, comprising:
a lower jamb formed from two sections that cooperate to define boundaries of a lower entryway, the sections comprising:
a first standing section; and
a second standing section extending parallel to the first standing section; and
a swinging lower door pivotally attached to the first standing section and positionable within the lower entryway;
a first splicing element that joins the first standing sections of the upper and lower jambs; and
a second splicing element that joins the second standing sections of the upper and lower jambs.

12. The entry device of claim 11 in which each of the first standing sections of each of the upper and lower jambs is characterized by a hollow end, and in which the first splicing element has opposed first and second ends, the first end telescopingly receivable within the hollow end of the first standing section of the upper jamb, and the second end telescopingly and concurrently receivable within the hollow end of the first standing section of the lower jamb.

13. The entry device of claim 11, further comprising:
an elongate and rigid door connection bracket that removably joins the upper and lower doors.

14. The entry device of claim 13 in which door connection bracket has the cross-sectional shape of the letter “L.”15. The entry device of claim 11, further comprising:
at least one elongate and rigid lower door positioning piece that removably interconnects the first and second standing sections of the lower jamb.

16. The entry device of claim 15 in which each door positioning piece comprises:
a flat and elongate bridge section configured to join the first and second standing sections of the lower jamb; and
a flat base section, shorter than the bridge section and configured to clear the first and second standing sections of the lower jamb and engage only the lower door, the base section being joined to the bridge section and extending in orthogonal relationship thereto.

17. The entry device of claim 11 in which each splicing element further comprises a circumferential skirt situated between its first and second ends.

18. The entry device of claim 11 in which the first standing section of the lower jamb is characterized by a hollow end, and further comprising:
a footing having a flat, enlarged and ground-engagable base that supports a compact and projecting tower, the tower receivable within the hollow end of the first standing section of the lower jamb.
